(19) United States
(12) Patent Application Publication
(10) Pub. No.: US 2020/0150407 A1
(43) Pub. Date: May 14, 2020

(54) ZOOM LENS, OPTICAL APPARATUS AND METHOD FOR MANUFACTURING THE ZOOM LENS

(71) Applicant: Nikon Corporation, Tokyo (JP)

(72) Inventors: Yasufumi Nishi, Edinburgh (GB); Takahiro Ishikawa, Kawasaki-shi (JP)

(21) Appl. No.: 16/743,887

(22) Filed: Jan. 15, 2020

Related U.S. Application Data
(62) Division of application No. 15/549,604, filed on Sep. 22, 2017, now abandoned.

(30) Foreign Application Priority Data
Feb. 24, 2015 (JP) 2015-034373
Feb. 24, 2015 (JP) 2015-034375

(51) Int. Cl. G02B 15/22; G02B 15/173

(52) U.S. Cl. CPC G02B 15/22; G02B 15/173

(57) ABSTRACT

A zoom lens comprises a first lens group (G1), a second lens group (G2), a third lens group (G3), a fourth lens group (G4), and a fifth lens group (G5) having positive refractive power. Upon zooming, the first lens group (G1), the second lens group (G2), the third lens group (G3), the fourth lens group (G4), and the fifth lens group (G5) are moved along an optical axis to change a distance between the first lens group (G1) and the second lens group (G2), a distance between the second lens group (G2) and the third lens group (G3), a distance between the third lens group (G3) and the fourth lens group (G4), and a distance between the fourth lens group (G4) and the fifth lens group (G5), in such a manner that the following conditional expression is satisfied.

2.30<f5/d4w<3.60

### TECHNICAL FIELD

The present invention relates to a zoom lens, an optical apparatus and a method for manufacturing a zoom lens.

### TECHNICAL BACKGROUND

A zoom lens suitable for photographic cameras, electronic still cameras, video cameras, and the like has conventionally been proposed (see, for example, Patent Document 1). A zoom lens including: a first lens group having positive refractive power; a second lens group having negative refractive power; a third lens group having positive refractive power; a fourth lens group having negative refractive power; and a fifth lens group having positive refractive power which are disposed in order from an object, and performing zooming by moving the lens groups has conventionally been proposed (see, for example, Patent Document 2).

### PRIOR ARTS LIST

### Patent Document

Patent Document 1: Japanese Laid-Open Patent Publication No. 2013-140307 (A)

Patent Document 2: Japanese Laid-Open Patent Publication No. 2012-247564 (A)

### SUMMARY OF THE INVENTION

### Problems to be Solved by the Invention

The conventional zoom lens has an exit pupil close to an image surface especially in a wide angle end state, involving a risk of what is known as shading that is optical vignetting on the image surface. Zoom lenses have recently been required to have higher optical performance.

### Means to Solve the Problems

To achieve the object described above, a zoom lens according to a first zoom lens invention comprises: a first lens group having positive refractive power; a second lens group having negative refractive power; a third lens group having positive refractive power; a fourth lens group having negative refractive power; and a fifth lens group having positive refractive power which are disposed in order from an object, wherein upon zooming from a wide angle end state to a telephoto end state, the first lens group, the second lens group, the third lens group, the fourth lens group, and the fifth lens group are moved along an optical axis to change a distance between the first lens group and the second lens group, a distance between the second lens group and the third lens group, a distance between the third lens group and the fourth lens group, and a distance between the fourth lens group and the fifth lens group, and wherein a following conditional expression is satisfied.

2.30<f5/d4w<3.60

where,

f5 denotes a focal length of the fifth lens group, and

d4W denotes a distance between the fourth lens group and the fifth lens group in the wide angle end state.

A zoom lens according to a second zoom lens invention comprises: a first lens group having positive refractive power; a second lens group having negative refractive power; a third lens group having positive refractive power; a fourth lens group having negative refractive power; and a fifth lens group having positive refractive power which are disposed in order from an object, wherein the fifth lens group is moved toward an image side upon zooming from a wide angle end state to a telephoto end state, and wherein a following conditional expression is satisfied.

1.96<f1/(fw×ft)^{1/2}<2.80

0.67<f4/(fw×ft)^{1/2}<2.10

where,

f1 denotes a focal length of the first lens group,

f4 denotes a focal length of the fourth lens group,

fw denotes a focal length of the zoom lens in the wide angle end state, and

ft denotes a focal length of the zoom lens in the telephoto end state.

An optical apparatus according to a first apparatus invention comprises the zoom lens according to the first invention described above. An optical apparatus according to a second apparatus invention comprises the zoom lens according to the second invention described above.

A method for manufacturing a zoom lens according to a first method invention including: a first lens group having positive refractive power; a second lens group having negative refractive power;

a third lens group having positive refractive power; a fourth lens group having negative refractive power; and a fifth lens group having positive refractive power which are disposed in order from an object, upon zooming from a wide angle end state to a telephoto end state, the first lens group, the second lens group, the third lens group, the fourth lens group, and the fifth lens group moving along an optical axis to change a distance between the first lens group and the second lens group, a distance between the second lens group and the third lens group, a distance between the third lens group and the fourth lens group, and a distance between the fourth lens group and the fifth lens group, according to the first invention comprises arranging the lenses in a lens barrel with a following conditional expression satisfied.

2.30<f5/d4w<3.60

where,

f5 denotes a focal length of the fifth lens group, and

d4W denotes a distance between the fourth lens group and the fifth lens group in the wide angle end state.

A method for manufacturing a zoom lens according to a second method invention including: a first lens group having positive refractive power; a second lens group having negative refractive power; a third lens group having positive refractive power; a fourth lens group having negative refractive power; and a fifth lens group having positive refractive power which are disposed in order from an object, the fifth lens group moving toward an image side upon zooming from a wide angle end state to a telephoto end state, according to a second invention comprises arranging the lenses in a lens barrel with a following conditional expression satisfied.

1.96<f1/(fw×ft)^{1/2}<2.80

0.67<f4/(fw×ft)^{1/2}<2.10

where,

f1 denotes a focal length of the first lens group,

f4 denotes a focal length of the fourth lens group,

fw denotes a focal length of the zoom lens in the wide angle end state, and

ft denotes a focal length of the zoom lens in the telephoto end state.

### BRIEF DESCRIPTION OF THE DRAWINGS

FIG. 1 is a cross-sectional view with sections (W), (M), and (T) showing a configuration of a zoom lens according to Example 1 respectively in a wide angle end state, an intermediate focal length state, and a telephoto end state.

FIGS. 2A, 2B, and 2C are graphs showing various aberrations of the zoom lens according to Example 1 upon focusing on infinity respectively in the wide angle end state, the intermediate focal length state, and the telephoto end state.

FIG. 3 is a cross-sectional view with sections (W), (M), and (T) showing a configuration of a zoom lens according to Example 2 respectively in the wide angle end state, the intermediate focal length state, and the telephoto end state.

FIGS. 4A, 4B, and 4C are graphs showing various aberrations of the zoom lens according to Example 2 upon focusing on infinity respectively in the wide angle end state, the intermediate focal length state, and the telephoto end state.

FIG. 5 is a cross-sectional view with sections (W), (M), and (T) showing a configuration of a zoom lens according to Example 3 respectively in the wide angle end state, the intermediate focal length state, and the telephoto end state.

FIGS. 6A, 6B, and 6C are graphs showing various aberrations of the zoom lens according to Example 3 upon focusing on infinity respectively in the wide angle end state, the intermediate focal length state, and the telephoto end state.

FIG. 7 is a cross-sectional view with sections (W), (M), and (T) showing a configuration of a zoom lens according to Example 4 respectively in the wide angle end state, the intermediate focal length state, and the telephoto end state.

FIGS. 8A, 8B, and 8C are graphs showing various aberrations of the zoom lens according to Example 4 upon focusing on infinity respectively in the wide angle end state, the intermediate focal length state, and the telephoto end state.

FIGS. 9A and 9B are respectively a front view and a rear view of a digital still camera according to 1st embodiment.

FIG. 10 is a cross-sectional view taken along a line indicated by arrows A-A′ in FIG. 9A.

FIG. 11 is a flowchart illustrating a method for manufacturing the zoom lens according to the 1st embodiment.

FIG. 12 is a cross-sectional view with sections (W), and (T) showing a configuration of a zoom lens according to Example 5 respectively in the wide angle end state, and the telephoto end state.

FIGS. 13A, 13B, and 13C are graphs showing various aberrations of the zoom lens according to Example 5 upon focusing on infinity respectively in the wide angle end state, the intermediate focal length state, and the telephoto end state.

FIG. 14 is a cross-sectional view with sections (W), and (T) showing a configuration of a zoom lens according to Example 6 respectively in the wide angle end state, and the telephoto end state.

FIGS. 15A, 15B, and 15C are graphs showing various aberrations of the zoom lens according to Example 6 upon focusing on infinity respectively in the wide angle end state, the intermediate focal length state, and the telephoto end state.

FIG. 16 is a cross-sectional view with sections (W), and (T) showing a configuration of a zoom lens according to Example 7 respectively in the wide angle end state, and the telephoto end state.

FIGS. 17A, 17B, and 17C are graphs showing various aberrations of the zoom lens according to Example 7 upon focusing on infinity respectively in the wide angle end state, the intermediate focal length state, and the telephoto end state.

FIG. 18 is a cross-sectional view with sections (W), and (T) showing a configuration of a zoom lens according to Example 8 respectively in the wide angle end state, and the telephoto end state. FIGS. 19A, 19B, and 19C are graphs showing various aberrations of the zoom lens according to Example 8 upon focusing on infinity respectively in the wide angle end state, the intermediate focal length state, and the telephoto end state.

FIGS. 20A and 20B are respectively a front view and a rear view of a digital still camera according to 2nd embodiment.

FIG. 21 is a cross-sectional view taken along a line indicated by arrows A-A′ in FIG. 20A.

FIG. 22 is a flowchart illustrating a method for manufacturing the zoom lens according to the 2nd embodiment.

### DESCRIPTION OF THE EMBODIMENTS

### 1st Embodiment

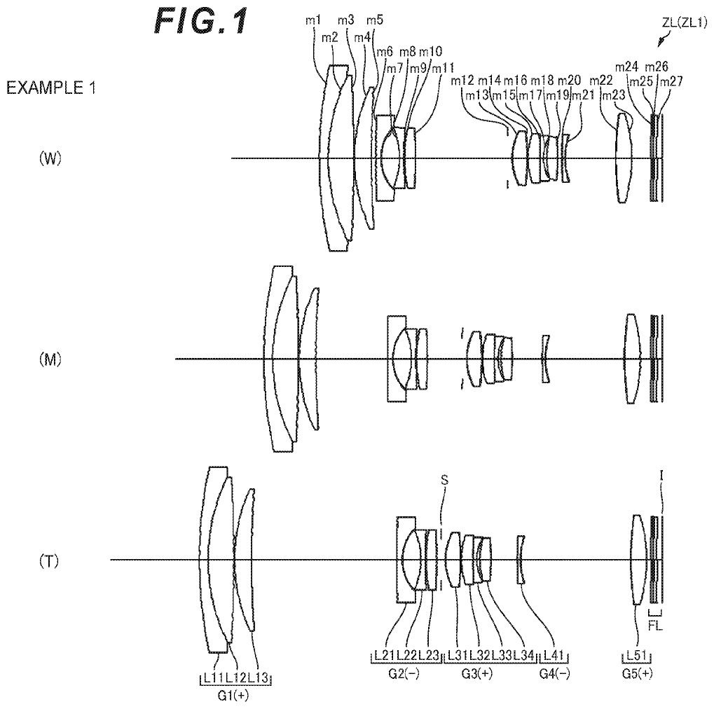

In the description below, 1st embodiment is described with reference to drawings. A zoom lens ZL according to the 1st embodiment includes, as illustrated in FIG. 1, a first lens group G1 having positive refractive power, a second lens group G2 having negative refractive power, a third lens group G3 having positive refractive power, a fourth lens group G4 having negative refractive power, and a fifth lens group

G5 having positive refractive power that are disposed in order from an object. Upon zooming from a wide angle end state to a telephoto end state, the first lens group G1, the second lens group G2, the third lens group G3, the fourth lens group G4, and the fifth lens group G5 are moved along the optical axis to change a distance between the first lens group G1 and the second lens group G2, a distance between the second lens group G2 and the third lens group G3, a distance between the third lens group G3 and the fourth lens group G4, and a distance between the fourth lens group G4 and the fifth lens group G5, in such a manner that the following conditional expression (1) is satisfied.

2.30<f5/d4w<3.60 (1)

where,

f5 denotes a focal length of the fifth lens group G5, and

d4W denotes the distance between the fourth lens group G4 and the fifth lens group G5 in the wide angle end state.

The configuration can achieve a zoom lens having a small size with an exit pupil position sufficiently distant from the image surface, and having high optical performance.

The conditional expression (1) is for setting the focal length of the fifth lens group G5 relative to the distance between the fourth lens group G4 and the fifth lens group G5 in the wide angle end state. The zoom lens ZL according to the 1st embodiment can have the exit pupil position sufficiently distant from the image surface in the wide angle end state, when the conditional expression (1) is satisfied.

A value higher than the upper limit value of the conditional expression (1) results in the exit pupil position too close to the image surface in the wide angle end state, resulting in what is known as shading that is optical vignetting on the image surface, and thus is not preferable When the exit pupil position is sufficiently distant from the image surface in the wide angle end state with a corresponding value of the conditional expression (1) being at the upper limit, large positive curvature of field occurs over the entire focal length.

To guarantee the effects of the 1st embodiment, the upper limit value of the conditional expression (1) is preferably set to be 3.40.

A value lower than the lower limit value of the conditional expression (1) results in the exit pupil position being too close to the image surface in the telephoto end state, and thus is not preferable. When the exit pupil position is sufficiently distant from the image surface in the telephoto end state with a corresponding value of the conditional expression (1) being at the lower limit, large negative curvature of field occurs over the entire focal length.

To guarantee the effects of the 1st embodiment, the lower limit value of the conditional expression (1) is preferably set to be 2.50.

The zoom lens ZL according to the 1st embodiment preferably satisfies the following conditional expression (2).

0.110<TLt×f3/(ft×ft)<0.134 (2)

where,

TLt denotes the total length of the whole zoom lens in the telephoto end state,

f3 denotes the focal length of the third lens group G3, and

ft denotes the focal length of the whole zoom lens in the telephoto end state.

The conditional expression (2) is for setting relationship between the total length of the whole zoom lens in the telephoto end state and the focal length of the third lens group G3. A short total length of the whole zoom lens ZL according to the 1st embodiment in the telephoto end state can be achieved, when the conditional expression (2) is satisfied.

A value higher than the upper limit value of the conditional expression (2) results in large positive spherical aberration over the entire focal length, and thus is not preferable.

To guarantee the effects of the 1st embodiment, the upper limit value of the conditional expression (2) is preferably set to be 0.130.

A value lower than the lower limit value of the conditional expression (2) results in large negative spherical aberration over the entire focal length, and thus is not preferable.

To guarantee the effects of the 1st embodiment, the lower limit value of the conditional expression (2) is preferably set to be 0.120.

Preferably, upon focusing from infinity to a short-distant object, the zoom lens ZL according to the 1st embodiment has the fourth lens group moved toward the image side as a focusing lens group with the following conditional expression (3) satisfied.

32.96<ft×ft/{(−f4)×d3t}<59.21 (3)

where,

ft denotes the focal length of the whole zoom lens in the telephoto end state,

f4 denotes a focal length of the fourth lens group G4, and

d3t denotes the distance between the third lens group G3 and the fourth lens group G4 in the telephoto end state.

The conditional expression (3) is for setting a focal length of the fourth lens group G4 and the distance between the third lens group G3 and the fourth lens group G4 in the telephoto end state. In the zoom lens ZL according to the 1st embodiment, an image surface movement coefficient of the fourth lens group G4 (a ratio of the movement amount of the image surface to the movement amount of the focusing lens group) can be set as appropriate, when the conditional expression (3) is satisfied.

A value higher than the upper limit value of the conditional expression (3) results in large positive spherical aberration in the fourth lens group G4, and thus is not preferable.

To guarantee the effects of the 1st embodiment, the upper limit value of the conditional expression (3) is preferably set to be 50.00.

A value lower than the lower limit value of the conditional expression (3) leads a large movement amount of the fourth lens group G4 upon focusing, resulting in a large total length of the whole zoom lens, and thus is not preferable.

To guarantee the effects of the 1st embodiment, the lower limit value of the conditional expression (3) is preferably set to be 30.00.

The zoom lens ZL according to the 1st embodiment preferably satisfies the following conditional expression (4).

1.00°<ωt<7.50° (4)

where,

ωt denotes a half angle of view in the telephoto end state.

The conditional expression (4) is for setting an optimum value of an angle of view in the telephoto end state. Various aberrations, such as a coma aberration, distortion, and curvature of field, can be successfully corrected, when the conditional expression (4) is satisfied.

To guarantee the effects of the 1st embodiment, the upper limit value of the conditional expression (4) is preferably set to be 7.00°. To more effectively guarantee the effects of the 1st embodiment, the upper limit value of the conditional expression (4) is preferably set to be 6.00°.

To guarantee the effects of the 1st embodiment, the lower limit value of the conditional expression (4) is preferably set to be 2.00°.

The zoom lens ZL according to the 1st embodiment preferably satisfies the following conditional expression (5).

32.00°<ωw<47.00° (5)

where,

ωw denotes a half angle of view in the wide angle end state.

The conditional expression (5) is for setting an optimum value of an angle of view in the wide angle end state. Various aberrations, such as a coma aberration, distortion, and curvature of field, can be successfully corrected while guaranteeing a wide angle of view, when the conditional expression (5) is satisfied.

To guarantee the effects of the 1st embodiment, the upper limit value of the conditional expression (5) is preferably set to be 45.00°.

To guarantee the effects of the 1st embodiment, the lower limit value of the conditional expression (5) is preferably set to be 33.00°. To more effectively guarantee the effects of the 1st embodiment, the lower limit value of the conditional expression (5) is preferably set to be 34.00°.

The zoom lens ZL according to the 1st embodiment preferably satisfies the following conditional expression (6).

1.70<f1/(fw×ft)^{1/2}<2.80 (6)

where,

f1 denotes a focal length of the first lens group G1,

fw denotes a focal length of the zoom lens ZL in the wide angle end state, and

ft denotes a focal length of the zoom lens ZL in the telephoto end state.

The conditional expression (6) is for setting a focal length of the first lens group G1. A spherical aberration and variation of aberration due to zooming can be reduced, when the conditional expression (6) is satisfied.

A value higher than the upper limit value of the conditional expression (6) leads to small refractive power of the first lens group G1, resulting in a large lens movement amount upon zooming and thus a large total length. Furthermore, the refractive power of the other lens groups increases, rendering various aberrations, such as curvature of field, in the telephoto end state difficult to correct.

To guarantee the effects of the 1st embodiment, the upper limit value of the conditional expression (6) is preferably set to be 2.50.

A value lower than the lower limit value of the conditional expression (6) leads to large refractive power of the first lens group G1, rendering various aberrations, such as spherical aberration and curvature of field, in the telephoto end state difficult to correct.

The zoom lens ZL according to the 1st embodiment preferably satisfies the following conditional expression (7).

0.67<f4/(fw×ft)^{1/2}<2.10 (7)

where,

f4 denotes a focal length of the fourth lens group G4, and

fw denotes a focal length of the zoom lens ZL in the wide angle end state, and

ft denotes a focal length of the zoom lens ZL in the telephoto end state.

The conditional expression (7) is for setting a focal length of the fourth lens group G4.

A value higher than the upper limit value of the conditional expression (7) renders various aberrations, such as curvature of field, difficult to correct.

To guarantee the effects of the 1st embodiment, the upper limit value of the conditional expression (7) is preferably set to be 1.70.

A value lower than the lower limit value of the conditional expression (7) renders various aberrations, such as curvature of field, difficult to correct.

To guarantee the effects of the 1st embodiment, the lower limit value of the conditional expression (7) is preferably set to be 0.75.

The zoom lens ZL according to the 1st embodiment preferably satisfies the following conditional expression (8).

0.100<Dm5/(fw×ft)^{1/2}<0.270 (8)

where,

Dm5 denotes a difference in the position of the fifth lens group G5 on the optical axis between the wide angle end state and the telephoto end state (with a value increasing in accordance with displacement toward the image side),

fw denotes a focal length of the zoom lens ZL in the wide angle end state, and

ft denotes a focal length of the zoom lens ZL in the telephoto end state.

The conditional expression (8) is for setting a movement amount of the fifth lens group G5.

A value higher than the upper limit value of the conditional expression (8) renders various aberrations, such as curvature of field, in the wide angle end state difficult to correct.

To guarantee the effects of the 1st embodiment, the upper limit value of the conditional expression (8) is preferably set to be 0.24.

A value lower than the lower limit value of the conditional expression (8) renders various aberrations, such as curvature of field, difficult to correct.

To guarantee the effects of the 1st embodiment, the lower limit value of the conditional expression (8) is preferably set to be 0.12. To more effectively guarantee the effects of the 1st embodiment, the lower limit value of the conditional expression (8) is preferably set to be 0.16.

The zoom lens ZL according to the 1st embodiment preferably satisfies the following conditional expression (9).

0.052<(−f2)/ft<0.150 (9)

where,

f2 denotes a focal length of the second lens group G2, and

ft denotes a focal length of the zoom lens ZL in the telephoto end state.

The conditional expression (9) is for setting relationship between the focal length of the second lens group G2 and the focal length of the zoom lens ZL in the telephoto end state. A spherical aberration and variation of aberration due to zooming can be reduced, when the conditional expression (9) is satisfied.

A value higher than the upper limit value of the conditional expression (9) leads to excessively small refractive power of the second lens group G2, resulting in larger refractive power of the other lens groups, rendering various aberrations, such as spherical aberration and curvature of field, difficult to correct. Furthermore, the movement amount of the second lens group G2 increases, leading to a larger optical total length and a large front lens diameter, rendering downsizing difficult.

A value lower than the lower limit value of the conditional expression (9) leads to excessively large refractive power of the second lens group G2, rendering various aberrations, such as astigmatism and curvature of field, difficult to correct.

The zoom lens ZL according to the 1st embodiment preferably satisfies the following conditional expression (10).

0.020<D5/ft<0.050 (10)

where,

D5 denotes a thickness of the fifth lens group G5 on the optical axis, and

ft denotes a focal length of the zoom lens ZL in the telephoto end state.

The conditional expression (10) is for setting relationship between the thickness of the fifth lens group G5 on the optical axis and the focal length of the zoom lens ZL in the telephoto end state.

A value higher than the upper limit value of the conditional expression (10) results in an increase in the thickness of the fifth lens group G5 on the optical axis. An attempt to maintain distances among the groups renders various aberrations, such as a coma aberration, difficult to correct.

To guarantee the effects of the 1st embodiment, the upper limit value of the conditional expression (10) is preferably set to be 0.041.

A value lower than the lower limit value of the conditional expression (10) leads to a small thickness of the fifth lens group G5 on the optical axis and small refractive power of the fifth lens group G5, rendering various aberrations, such as curvature of field, difficult to correct.

To guarantee the effects of the 1st embodiment, the lower limit value of the conditional expression (10) is preferably set to be 0.025.

The zoom lens ZL according to the 1st embodiment preferably satisfies the following conditional expression (11).

0.005<(−Dm4)/ft<0.100 (11)

where,

Dm4 denotes a difference in a position of the fourth lens group G4 on the optical axis between the wide angle end state and the telephoto end state (with a value increasing in accordance with displacement toward the image side), and

ft denotes a focal length of the zoom lens ZL in the telephoto end state.

The conditional expression (11) is for setting a movement amount of the fourth lens group G4.

A value higher than the upper limit value of the conditional expression (11) renders various aberrations, such as curvature of field and lateral chromatic aberration, difficult to correct, when the refractive power of the other lens groups is increased to maintain the optical total length.

To guarantee the effects of the 1st embodiment, the upper limit value of the conditional expression (11) is preferably set to be 0.080. To more effectively guarantee the effects of the 1st embodiment, the upper limit value of the conditional expression (11) is preferably set to be 0.075. To more effectively guarantee the effects of the 1st embodiment, the upper limit value of the conditional expression (11) is preferably set to be 0.070.

A value lower than the lower limit value of the conditional expression (11) renders various aberrations, such as spherical aberration and on-axis chromatic aberration, difficult to correct.

With the zoom lens ZL according to the 1st embodiment having the configuration described above, a zoom lens having a small size with an exit pupil position sufficiently distant from the image surface, and having high optical performance can be achieved.

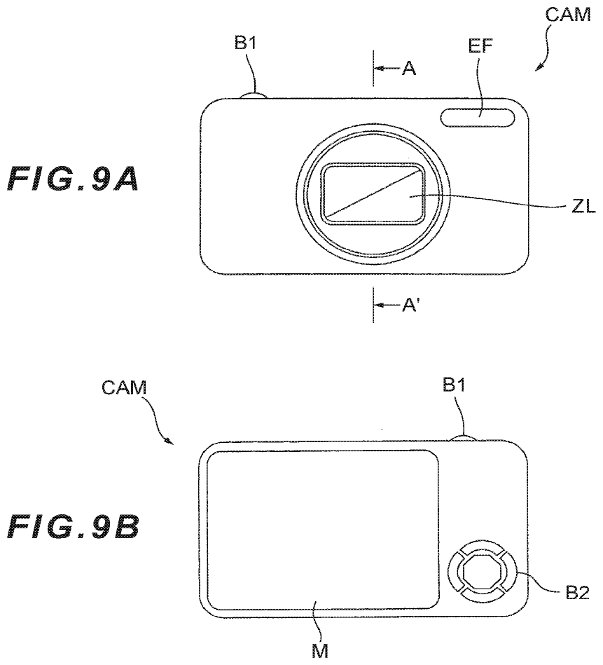

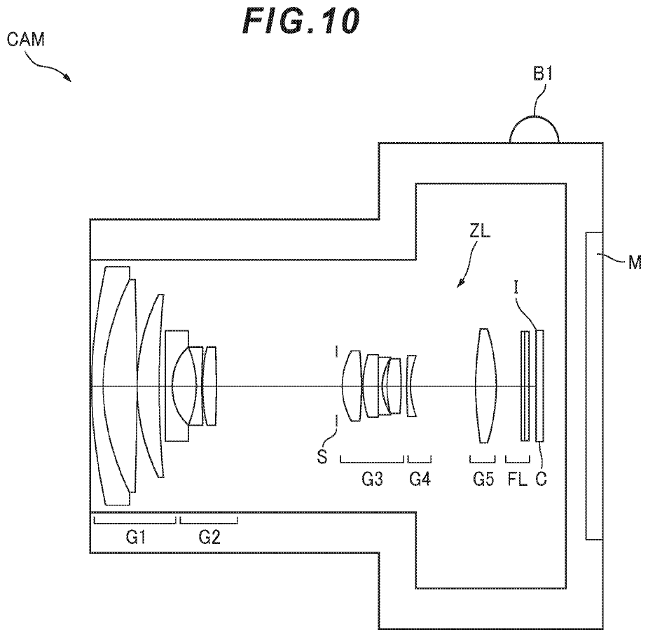

FIGS. 9A and 9B, and FIG. 10 illustrate a configuration of a digital still camera CAM (optical apparatus) that is an optical apparatus including the zoom lens ZL according to the 1st embodiment. When a power button (not illustrated) is pressed, in the digital still camera CAM, a shutter (not illustrated) of an imaging lens (the zoom lens ZL) opens. Thus, light from a subject (object) is focused by the zoom lens ZL and formed on an image sensor C (such as a CCD or a CMOS for example) disposed on an image surface I (see FIG. 1). A subject image thus formed on the image sensor C is displayed on a liquid crystal monitor M provided on a back side of the digital still camera CAM. A photographer determines a composition of the subject image while viewing the liquid crystal monitor M, and thus presses down a release button B1 to capture the subject image with the image sensor C. The image is recorded and stored in a memory (not illustrated). The photographer can capture an image of a subject with the camera CAM in the manner described above.

The camera CAM further includes: an auxiliary light emitting unit EF that emits auxiliary light when a subject is dark; and a function button B2 used for setting various conditions of the digital still camera CAM.

In this example, a compact type camera with the camera CAM and the zoom lens ZL integrally formed is described. The optical apparatus may also be a single-lens reflex camera with a lens barrel including the zoom lens ZL and a camera body that can be detachably attached to each other.

With the camera CAM according to the 1st embodiment having the configuration described above including the zoom lens ZL serving as the imaging lens, a camera having a small size with an exit pupil position sufficiently distant from the image surface, and having high optical performance can be achieved.

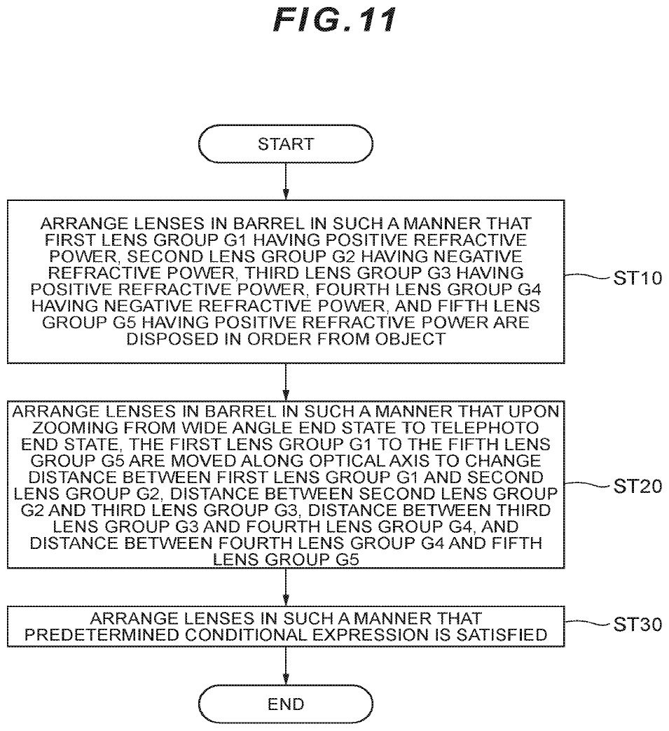

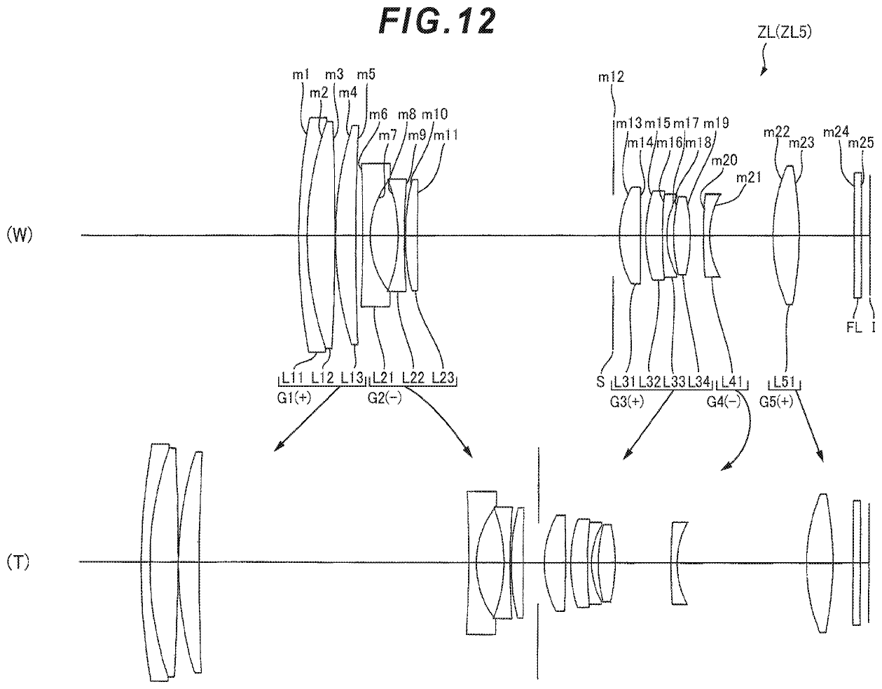

Next, a method for manufacturing the zoom lens ZL according to the 1st embodiment is described with reference to FIG. 11. First of all, the lenses are arranged in a barrel in such a manner that the first lens group G1 having positive refractive power, the second lens group G2 having negative refractive power, the third lens group G3 having positive refractive power, the fourth lens group G4 having negative refractive power, and the fifth lens group G5 having positive refractive power are disposed in order from the object (step ST10). The lenses are arranged in such a manner that upon zooming from the wide angle end state to the telephoto end state, the first lens group G1, the second lens group G2, the third lens group G3, the fourth lens group G4, and the fifth lens group G5 are moved along the optical axis to change a distance between the first lens group G1 and the second lens group G2, a distance between the second lens group G2 and the third lens group G3, a distance between the third lens group G3 and the fourth lens group G4, and a distance between the fourth lens group G4 and the fifth lens group G5 (step ST20). The lenses are arranged in such a manner that the following conditional expression (1) is satisfied (step ST30).

2.30<f5/d4w<3.60 (1)

where,

f5 denotes the focal length of the fifth lens group G5, and

d4W denotes the distance between the fourth lens group G4 and the fifth lens group G5 in the wide angle end state.

An example of the lens arrangement according to the 1st embodiment is described. Specifically, as illustrated in FIG. 1, the first to the fifth lens groups G1-G5 are disposed in order from the object. The first lens group G1 includes: a cemented lens including a negative meniscus lens L11 having a concave surface facing the image side and a biconvex lens L12; and a positive meniscus lens L13 having a convex surface facing the object side, disposed in order from the object. The second lens group G2 includes: a negative meniscus lens L21 having a concave surface facing the image side; a biconcave lens L22; and a biconvex lens L23, disposed in order from the object. The third lens group G3 includes: a biconvex lens L31; a cemented lens including a positive meniscus lens L32 having a convex surface facing the object side and a negative meniscus lens L33 having a concave surface facing the image side; and a biconvex lens L34 disposed in order from the object. The fourth lens group G4 includes a negative meniscus lens L41 having a concave surface facing the image side. The fifth lens group G5 includes a biconvex lens L51. The zoom lens ZL is manufactured by arranging lens groups thus prepared in the manner described above.

With the manufacturing method according to the 1st embodiment described above, a zoom lens ZL having a small size with an exit pupil position sufficiently distant from the image surface, and having high optical performance can be manufactured.

### Example According to 1st Embodiment

Examples according to the 1st embodiment are described with reference to the drawings. FIGS. 1, 3, 5, and 7 are cross-sectional views illustrating configurations and refractive power distributions of zoom lenses ZL (ZL1 to ZL4) according to Examples. Each cross-sectional view illustrates the positions of the lens groups in a process of zooming from the wide angle end state (W) to the telephoto end state (T) via the intermediate focal length state (M).

Reference signs in FIG. 1 corresponding to Example 1 are independently provided for each Example, to avoid complication of description due to increase in the number of digits of the reference signs. Thus, reference signs that are the same as those in a drawing corresponding to another Example do not necessarily indicate a configuration that is the same as that in the other Example.

Table 1 to Table 4 described below are specification tables of Examples 1 to 4.

In Examples, d-line (wavelength 587.6 nm) and g-line (wavelength 435.8 nm) are selected as calculation targets of the aberration characteristics.

In [Lens specifications] in the tables, a surface number represents an order of an optical surface from the object side in a traveling direction of a light beam, R represents a radius of curvature of each optical surface, D represents a distance between each optical surface and the next optical surface (or the image surface) on the optical axis, vd represents Abbe number of the material of the optical member based on the d-line, and nd represents a refractive index of a material of an optical member with respect to the d-line. Furthermore, Di represents a distance between an ith surface and an (i+1) th surface, a radius of curvature of “0.0000” represents an aperture or a planer surface, (stop S) represents the aperture stop S, and Bf represents back focus (a distance between a lens last surface and a paraxial image surface on the optical axis). The refractive index “1.000000” of air is omitted. An aspherical optical surface has a * mark in the field of surface number and has a paraxial radius of curvature in the field of radius of curvature R.

In the tables, [Aspherical surface data] has the following formula (a) indicating the shape of an aspherical surface in [Lens specifications]. In the formula, X(y) represents a distance between the tangent plane at the vertex of the aspherical surface and a position on the aspherical surface at a height y along the optical axis direction, R represents a radius of curvature (paraxial radius of curvature) of a reference spherical surface, κ represents a conical coefficient, and Ai represents an ith aspherical coefficient. In the formula, “E−n” represents “×10⁻ⁿ”. For example, 1.234E−05=1.234×10⁻⁵. A secondary aspherical coefficient A2 is 0, and thus is omitted.

X(y)=(y²/R)/{1+(1−κ×y²/R²)^{1/2}}+A4×y⁴+A6×y⁶+A8×y⁸ (a)

In the tables, [Various data] includes data on states such as the wide angle end state, the intermediate focal length state, and the telephoto end state upon focusing on infinity. Specifically, f represents a focal length of the whole zoom lens, FNO represents an F number, ω represents a half angle of view (unit: °), Di represents a distance between an ith surface and an (i+1) th surface, Bf represents the distance between a lens last surface and a paraxial image surface on the optical axis, and TL represents the length of the whole zoom lens (a value obtained by adding Bf to the distance between the lens forefront surface and the lens last surface on the optical axis). Furthermore, values of an exit pupil position (the distance from the image surface) and the image surface movement coefficient of the fourth lens group G4 upon focusing on infinity are described.

In [Lens group data] in the tables, the starting surface and the focal length of each of the lens groups are described.

In [Conditional expression corresponding value] in the tables, values corresponding to the conditional expressions (1) to (11) are described.

The focal length f, the radius of curvature R, the surface distance D and the other units of length described below as all the specification values, which are generally described with “mm” unless otherwise noted should not be construed in a limiting sense because the optical system proportionally expanded or reduced can have a similar or the same optical performance. The unit is not limited to “mm”, and other appropriate units may be used.

The description on the tables described above commonly applies to all Examples 1 to 4, and thus will not be described below.

### EXAMPLE 1

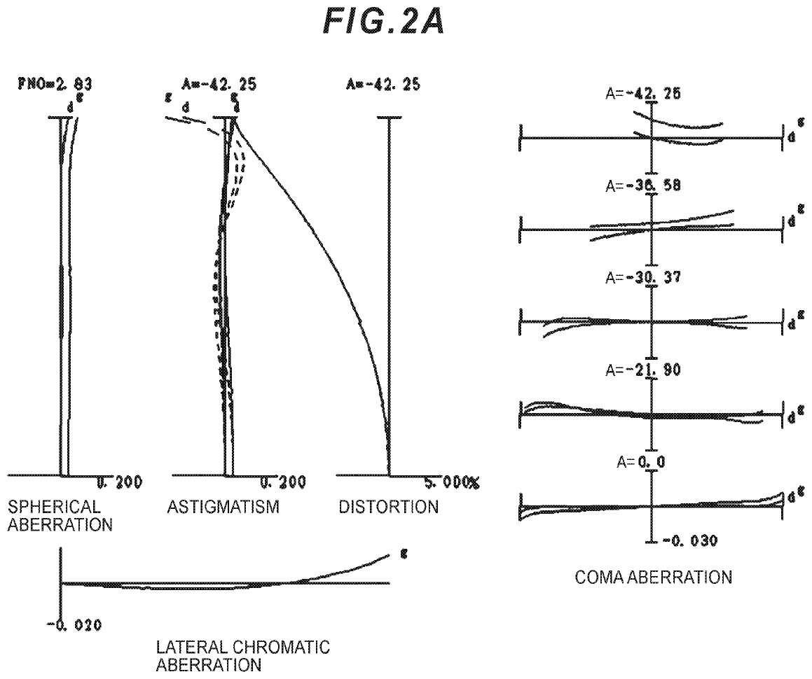

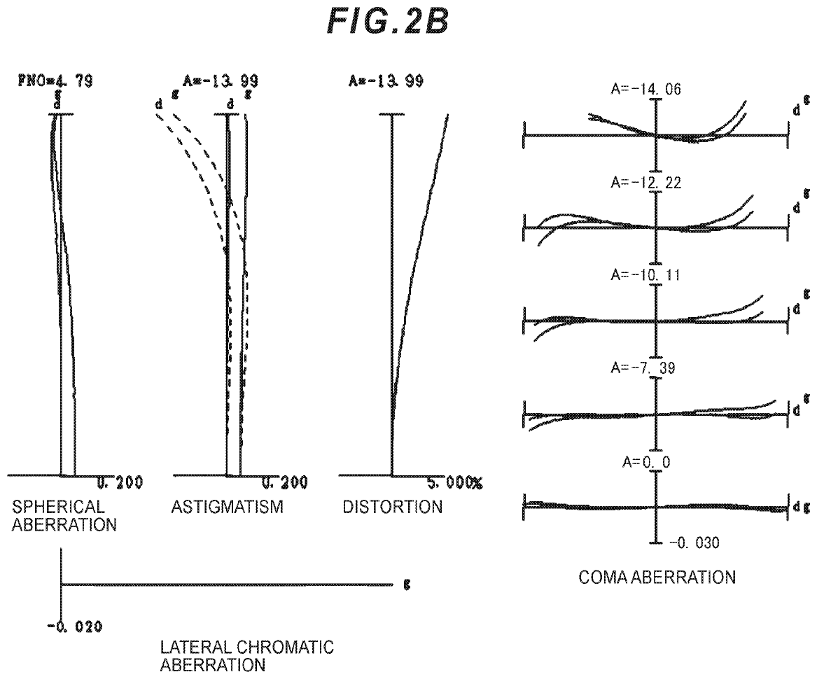

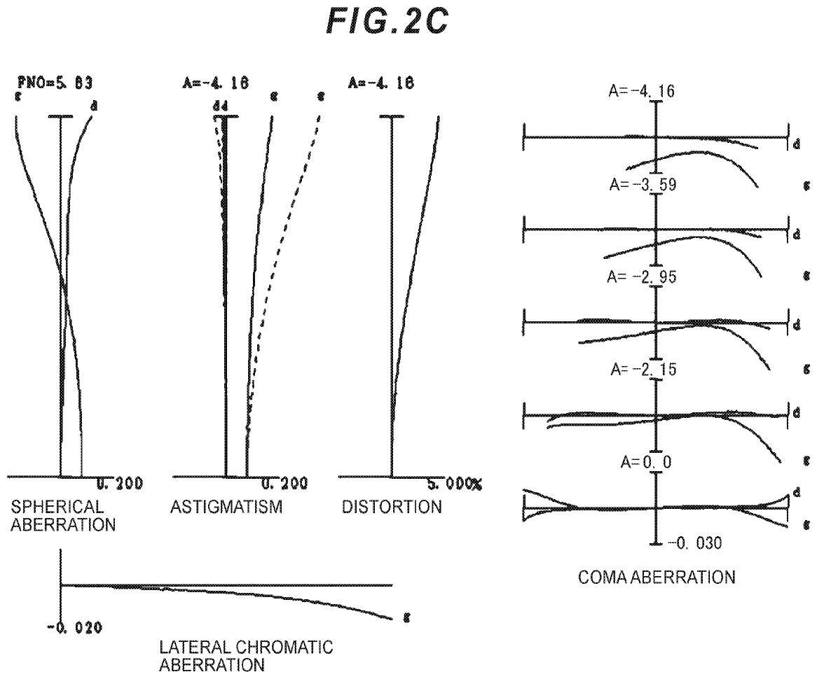

Next, Example 1 is described with reference to FIG. 1, FIGS. 2A-2C, and Table 1. As illustrated in FIG. 1, the zoom lens ZL (ZL1) according to Example 1 includes: a first lens group G1 having positive refractive power; a second lens group G2 having negative refractive power; a third lens group G3 having positive refractive power; a fourth lens group G4 having negative refractive power; and a fifth lens group G5 having positive refractive power which are disposed in order from an object.

The first lens group G1 includes: a cemented lens including a negative meniscus lens L11 having a concave surface facing the image side and a biconvex lens L12; and a positive meniscus lens L13 having a convex surface facing the object side, which are disposed in order from the object.

The second lens group G2 includes: a negative meniscus lens L21 having a concave surface facing the image side; a biconcave lens L22; and a biconvex lens L23, which are disposed in order from the object. The negative meniscus lens L21 has an aspherical surface on the image side.

The third lens group G3 includes: a biconvex lens L31; a cemented lens including a positive meniscus lens L32 having a convex surface facing the object side and a negative meniscus lens L33 having a concave surface facing the image side; and a biconvex lens L34 disposed in order from the object. The biconvex lens L31 has aspherical surfaces on both sides.

The fourth lens group G4 includes a negative meniscus lens L41 having a concave surface facing the image side. The negative meniscus lens L41 has an aspherical surface on the image side.

The fifth lens group G5 includes a biconvex lens L51. The biconvex lens L51 has aspherical surfaces on the object side.

An aperture stop S, for adjusting the amount of light, is disposed adjacent to and more on the object side than the third lens group G3.

A filter FL is disposed adjacent to and more on the image side than the fifth lens group G5. The filter FL includes a lowpass filter and an infrared cut filter for cutting the spatial frequency overwhelming the resolution limit of a solid-state image sensor such as a CCD provided on the image surface I.

The zoom lens ZL1 according to the present example performs zooming by changing the distances among the lens groups. Specifically, upon zooming from the wide angle end state to the telephoto end state, the first lens group G1 is moved toward the object side, the second lens group G2 is moved toward the image side, the third lens group G3 is moved toward the object side, the fourth lens group G4 is moved toward the object side, and the fifth lens group G5 is moved toward the image side. The aperture stop S integrally moves with the third lens group G3 toward the object side.

In Table 1 below, specification values in Example 1 are listed. Surface numbers 1 to 27 in Table 1 respectively correspond to the optical surfaces m1 to m27 in FIG. 1.

TABLE 1
[Lens specifications]

| Surface | | | | |
|---|---|---|---|---|
| number | R | D | νd | nd |
| 1 | 80.5818 | 2.0000 | 33.34 | 1.806100 |
| 2 | 35.3732 | 5.8000 | 81.73 | 1.497000 |
| 3 | −310.9288 | 0.2000 | | |
| 4 | 32.6650 | 3.8000 | 65.44 | 1.603000 |
| 5 | 172.0246 | (D5 = Variable) | | |
| 6 | 395.3632 | 1.2000 | 47.18 | 1.773770 |
| *7 | 8.8758 | 4.1783 | | |
| 8 | −14.9127 | 1.0000 | 47.35 | 1.788000 |
| 9 | 84.6771 | 0.2000 | | |
| 10 | 29.3689 | 2.4000 | 17.98 | 1.945950 |
| 11 | −97.0100 | (D11 = Variable) | | |
| 12 | 0.0000 | 1.0000 | (Aperture | |
| | | | stop S) | |
| *13 | 10.6750 | 3.4000 | 63.86 | 1.618810 |
| *14 | −37.8678 | 0.2000 | | |
| 15 | 14.7458 | 2.7000 | 61.22 | 1.589130 |
| 16 | 247.2379 | 0.8000 | 31.27 | 1.903660 |
| 17 | 8.2544 | 0.7000 | | |
| 18 | 14.1122 | 2.5000 | 63.34 | 1.618000 |
| 19 | −48.5262 | (D19 = Variable) | | |
| 20 | 93.6140 | 0.7000 | 81.49 | 1.497100 |
| *21 | 13.9237 | (D21 = Variable) | | |
| *22 | 47.3733 | 3.6000 | 63.86 | 1.618810 |
| 23 | −28.0497 | (D23 = Variable) | | |
| 24 | 0.0000 | 0.4700 | 63.88 | 1.516800 |
| 25 | 0.0000 | 0.1500 | | |
| 26 | 0.0000 | 0.7000 | 63.88 | 1.516800 |
| 27 | 0.0000 | (Bf) | | |

[Aspherical surface data]
7th surface
κ = 1.2984
A4 = −6.14616E−05
A6 = −8.09197E−07
A8 = 0.00000E+00
13th surface
κ = 0.3130
A4 = −1.02252E−05
A6 = 2.40979E−07
A8 = −1.38343E−09
14th surface
κ = 1.0000
A4 = 5.84552E−05
A6 = −3.91089E−08
A8 = 0.00000E+00
21th surface
κ = 1.0000
A4 = 2.76226E−05
A6 = −3.81969E−07
A8 = 0.00000E+00
22th surface
κ = 1.0000
A4 = −4.54093E−05
A6 = 2.41061E−07
A8 = 0.00000E+00
[Various data]
Zooming rate 11.90

| | Wide angle | Intermediate | Telephoto |
|---|---|---|---|
| f | 9.05000 | 31.22000 | 107.62999 |
| FNO | 2.83 | 4.79 | 5.63 |
| ω | 42.25 | 13.99 | 4.16 |
| D5 | 0.99990 | 16.26217 | 33.03140 |
| D11 | 20.95447 | 7.95083 | 0.99914 |
| D19 | 1.00045 | 6.84062 | 6.00045 |
| D21 | 11.50000 | 17.92550 | 24.98447 |
| D23 | 4.36297 | 2.40885 | 1.00573 |
| Bf | 1.28000 | 1.28000 | 1.28000 |
| TL | 77.79608 | 90.36626 | 104.99947 |
| Exit pupil position | −72.66071 | 1357.75462 | 140.36196 |
| G4 image surface | −1.03009 | −1.44686 | −2.04673 |
| movement coefficient | | | |
| (Upon focusing on infinity) | | | |

[Lens group data]

| Group | Group starting | Group focal |
|---|---|---|
| number | surface | length |
| G1 | 1 | 56.14511 |
| G2 | 6 | −9.37374 |
| G3 | 13 | 14.04617 |
| G4 | 20 | −33.00000 |
| G5 | 22 | 29.00000 |

[Conditional expression corresponding value]

Conditional expression (1) f5/d4w = 2.522
Conditional expression (2) TLt × f3/(ft × ft) = 0.127
Conditional expression (3) ft × ft/{(−f4) × d3t} = 58.502
Conditional expression (4) ωt = 4.16
Conditional expression (5) ωw = 42.25
Conditional expression (6) f1/(fw × ft)^{1/2} = 1.799
Conditional expression (7) f4/(fw × ft)^{1/2} = 1.057
Conditional expression (8) Dm5/(fw × ft)^{1/2} = 0.108
Conditional expression (9) −f2/ft = 0.087
Conditional expression (10) D5/ft = 0.033
Conditional expression (11) (−Dm4)/ft = 0.094

It can be seen in Table 1 that the zoom lens ZL1 according to Example 1 satisfies the conditional expressions (1) to (11).

FIGS. 2A, 2B, and 2C are various aberration graphs (a spherical aberration graph, an astigmatism graph, a distortion graph, a coma aberration graph, and a lateral chromatic aberration graph) of the zoom lens ZL1 according to Example 1 upon focusing on infinity with FIG. 2A corresponding to the wide angle end state, FIG. 2B corresponding to the intermediate focal length state, and FIG. 2C corresponding to the telephoto end state.

In the aberration graphs, FNO represents an F number, A represents a half angle of view at each image height (unit: °), and d and g respectively represent aberrations on the d-line and the g-line.

Those denoted with none of the above represent aberrations on the d-line. In an astigmatism graph, a solid line represents a sagittal image surface, and a broken line represents a meridional image surface. The lateral chromatic aberration graph is illustrated based on the d-line. In aberration graphs in Examples described below, the same reference signs as in this Example are used.

It can be seen in the aberration graphs in FIGS. 2A, 2B, and 2C that the zoom lens ZL1 according to Example 1 can achieve an excellent imaging performance with various aberrations successfully corrected from the wide angle end state to the telephoto end state.

### EXAMPLE 2

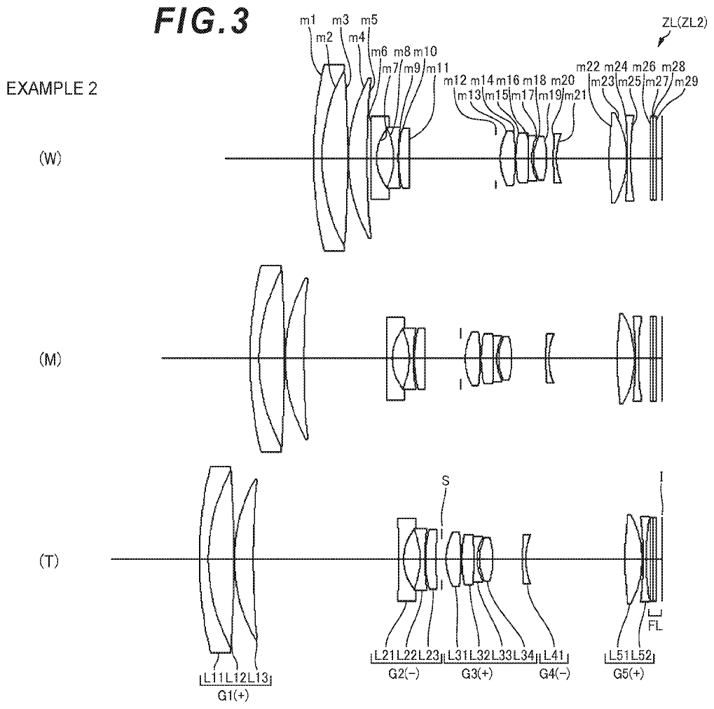

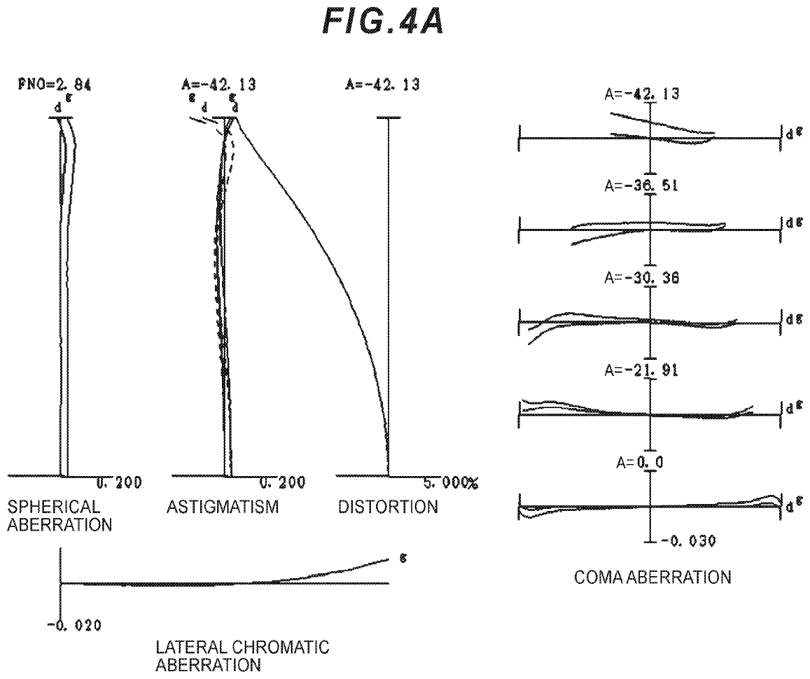

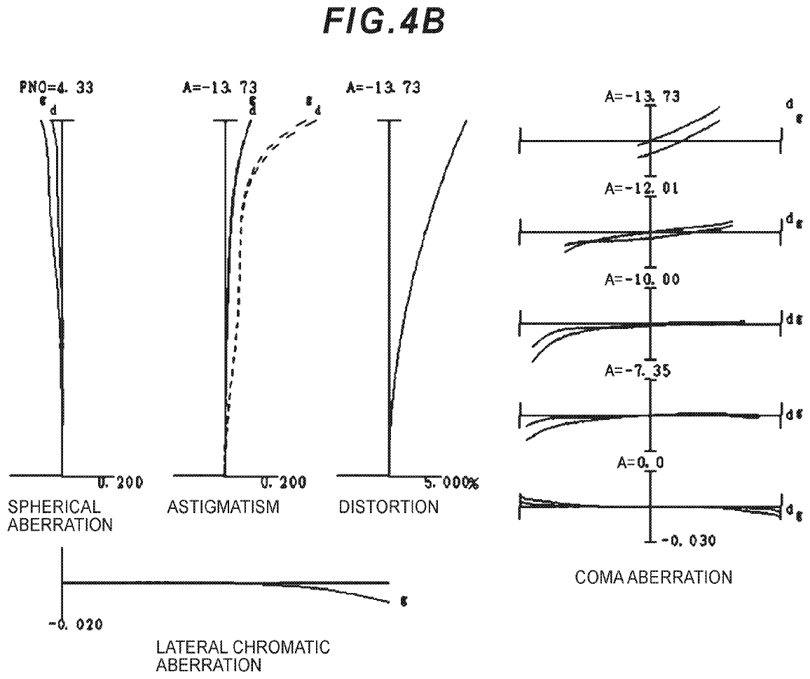

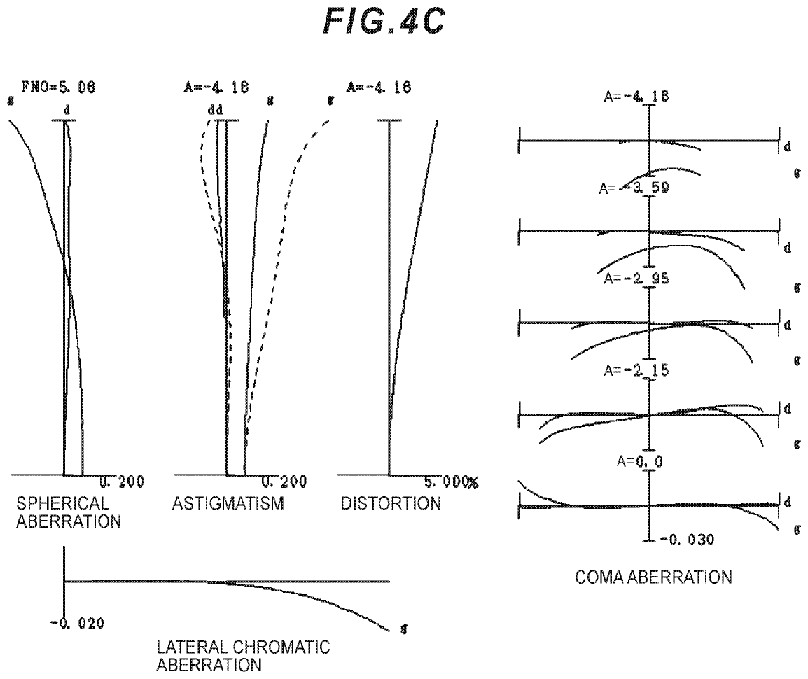

Example 2 is described with reference to FIG. 3, FIGS. 4A-4C, and Table 2. As illustrated in FIG. 3, a zoom lens ZL (ZL2) according to Example 2 includes: a first lens group G1 having positive refractive power; a second lens group G2 having negative refractive power; a third lens group G3 having positive refractive power; a fourth lens group G4 having negative refractive power; and a fifth lens group G5 having positive refractive power which are disposed in order from an object.

The first lens group G1 includes: a cemented lens including a negative meniscus lens L11 having a concave surface facing the image side and a biconvex lens L12; and a positive meniscus lens L13 having a convex surface facing the object side, which are disposed in order from the object.

The second lens group G2 includes: a biconcave lens L21; a biconcave lens L22; and a positive meniscus lens L23 having a convex surface facing the object side which are arranged in order from an object. The biconcave lens L21 has an aspherical surface on the image side.

The third lens group G3 includes: a biconvex lens L31; a cemented lens including a biconvex lens L32 and a biconcave lens L33; and a biconvex lens L34, which are disposed in order from an object. The biconvex lens L31 has aspherical surfaces on both sides.

The fourth lens group G4 includes a negative meniscus lens L41 having a concave surface facing the image side. The negative meniscus lens L41 has an aspherical surface on the image side.

The fifth lens group G5 includes a biconvex lens L51 and a biconcave lens L52, which are disposed in order from an object. The biconvex lens L51 has aspherical surfaces on the object side.

An aperture stop S, for adjusting the amount of light, is provided adjacent to and more on the object side than the third lens group G3.

A filter FL is disposed adjacent to and more on the image side than the fifth lens group G5. The filter FL includes a lowpass filter and an infrared cut filter for cutting the spatial frequency overwhelming the resolution limit of a solid-state image sensor such as a CCD provided on the image surface I.

The zoom lens ZL2 according to the present example performs zooming by changing the distances among the lens groups. Specifically, upon zooming from the wide angle end state to the telephoto end state, the first lens group G1 is moved toward the object side, the second lens group G2 is moved toward the image side, the third lens group G3 is moved toward the object side, the fourth lens group G4 is moved toward the object side, and the fifth lens group G5 is moved toward the image side. The aperture stop S integrally moves with the third lens group G3 toward the object side.

In Table 2 below, specification values in Example 2 are listed. Surface numbers 1 to 29 in Table 2 respectively correspond to the optical surfaces m1 to m29 in FIG. 3.

TABLE 2
[Lens specifications]

| Surface | | | | |
|---|---|---|---|---|
| number | R | D | νd | nd |
| 1 | 76.2344 | 2.0000 | 32.35 | 1.850260 |
| 2 | 35.7754 | 5.8000 | 81.73 | 1.497000 |
| 3 | −251.4384 | 0.2000 | | |
| 4 | 32.4653 | 4.2000 | 63.34 | 1.618000 |
| 5 | 162.8377 | (D5 = Variable) | | |
| 6 | −498.3647 | 1.2000 | 42.71 | 1.820800 |
| *7 | 8.9882 | 3.8302 | | |
| 8 | −14.5008 | 1.0000 | 63.34 | 1.618000 |
| 9 | 40.7175 | 0.2000 | | |
| 10 | 23.0595 | 2.4000 | 17.98 | 1.945950 |
| 11 | 371.2358 | (D11 = Variable) | | |
| 12 | 0.0000 | 1.0000 | (Aperture | |
| | | | stop S) | |
| *13 | 10.7088 | 3.4000 | 63.86 | 1.618810 |
| *14 | −32.1510 | 0.2000 | | |
| 15 | 22.6681 | 2.7000 | 81.73 | 1.497000 |
| 16 | −286.2185 | 0.8000 | 35.73 | 1.902650 |
| 17 | 8.8334 | 0.5000 | | |
| 18 | 10.4942 | 3.0000 | 70.31 | 1.487490 |
| 19 | −17.3199 | (D19 = Variable) | | |
| 20 | 80.0181 | 0.7000 | 81.49 | 1.497100 |
| *21 | 13.1218 | (D21 = Variable) | | |
| *22 | 36.0879 | 4.0000 | 55.48 | 1.696800 |
| 23 | −17.6361 | 0.2000 | | |
| 24 | −73.2519 | 0.7000 | 25.64 | 1.784720 |
| 25 | 53.4182 | (D25 = Variable) | | |
| 26 | 0.0000 | 0.4700 | 63.88 | 1.516800 |
| 27 | 0.0000 | 0.1500 | | |
| 28 | 0.0000 | 0.7000 | 63.88 | 1.516800 |
| 29 | 0.0000 | (Bf) | | |

[Aspherical surface data]
7th surface
κ = 1.2687
A4 = −5.90233E−05
A6 = −7.28217E−07
A8 = 0.00000E+00
13th surface
κ = 1.6811
A4 = −1.43502E−04
A6 = −4.95404E−07
A8 = −1.90765E−08
14th surface
κ = 1.0000
A4 = 1.11413E−04
A6 = 9.30435E−08
A8 = 0.00000E+00
21th surface
κ = 1.0000
A4 = 1.75131E−05
A6 = 6.80438E−07
A8 = 0.00000E+00
22th surface
κ = 1.0000
A4 = −8.71678E−05
A6 = 8.78795E−08
A8 = 0.00000E+00
[Various data]
Zooming rate 11.90

| | Wide angle | Intermediate | Telephoto |
|---|---|---|---|
| f | 9.05000 | 31.22000 | 107.62999 |
| FNO | 2.84 | 4.34 | 5.05 |
| ω | 42.13 | 13.73 | 4.16 |
| D5 | 0.99994 | 18.84504 | 32.91964 |
| D11 | 19.61599 | 8.15978 | 1.22688 |
| D19 | 1.50025 | 7.72395 | 6.80025 |
| D21 | 11.90013 | 15.39404 | 22.42393 |
| D25 | 4.52290 | 2.74031 | 0.99909 |
| Bf | 1.28000 | 1.28000 | 1.28000 |
| TL | 79.16940 | 93.49332 | 104.99999 |
| Exit pupil position | −76.83374 | −305.41689 | 255.51496 |
| G4 image surface | −1.09833 | −1.30211 | −1.84275 |
| movement coefficient | | | |
| (Upon focusing on infinity) | | | |

[Lens group data]

| Group | Group starting | Group focal |
|---|---|---|
| number | surface | length |
| G1 | 1 | 53.99261 |
| G2 | 6 | −8.61000 |
| G3 | 13 | 14.19468 |
| G4 | 20 | −31.68441 |
| G5 | 22 | 30.00000 |

[Conditional expression corresponding value]

Conditional expression (1) f5/d4w = 2.521
Conditional expression (2) TLt × f3/(ft × ft) = 0.129
Conditional expression (3) ft × ft/{(−f4) × d3t} = 53.765
Conditional expression (4) ωt = 4.16
Conditional expression (5) ωw = 42.13
Conditional expression (6) f1/(fw × ft)^{1/2} = 1.730
Conditional expression (7) f4/(fw × ft)^{1/2} = 1.015
Conditional expression (8) Dm5/(fw × ft)^{1/2} = 0.113
Conditional expression (9) −f2/ft = 0.080
Conditional expression (10) D5/ft = 0.046
Conditional expression (11) (−Dm4)/ft = 0.065

It can be seen in Table 2 that the zoom lens ZL2 according to Example 2 satisfies the conditional expressions (1) to (11).

FIGS. 4A, 4B, and 4C are various aberration graphs (a spherical aberration graph, an astigmatism graph, a distortion graph, a coma aberration graph, and a lateral chromatic aberration graph) of the zoom lens ZL2 according to Example 2 upon focusing on infinity with FIG. 4A corresponding to the wide angle end state, FIG. 4B corresponding to the intermediate focal length state, and FIG. 4C corresponding to the telephoto end state.

It can be seen in the aberration graphs in FIGS. 4A, 4B, and 4C that the zoom lens ZL2 according to Example 2 can achieve an excellent imaging performance with various aberrations successfully corrected from the wide angle end state to the telephoto end state.

### EXAMPLE 3

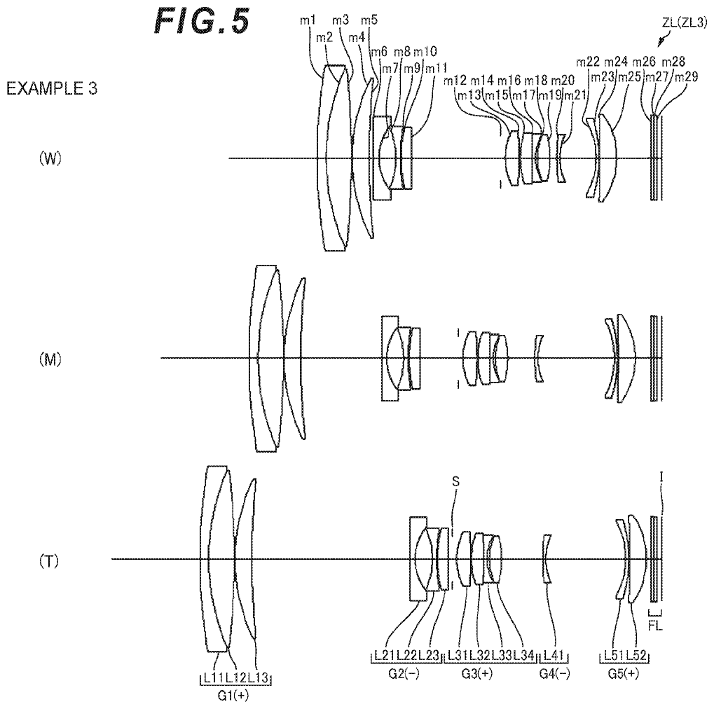

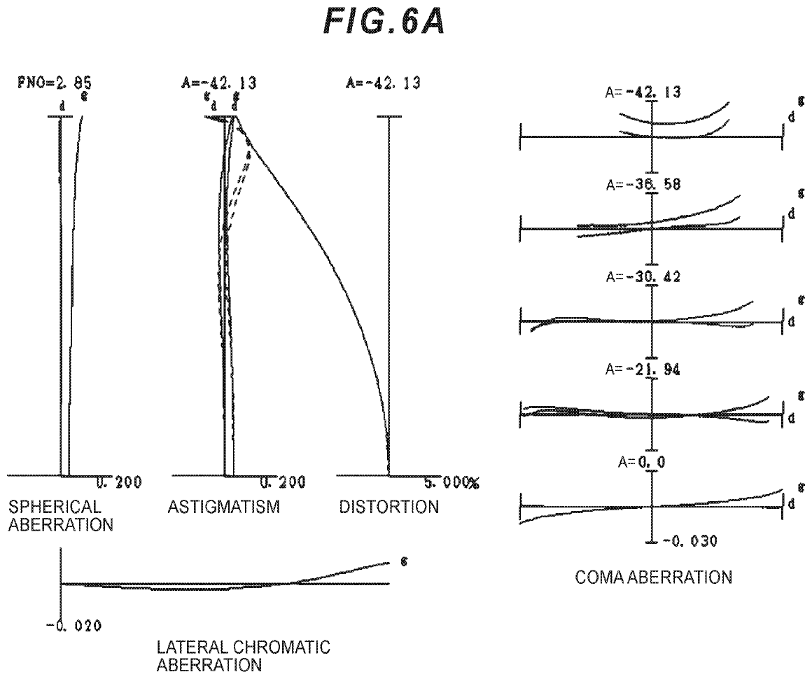

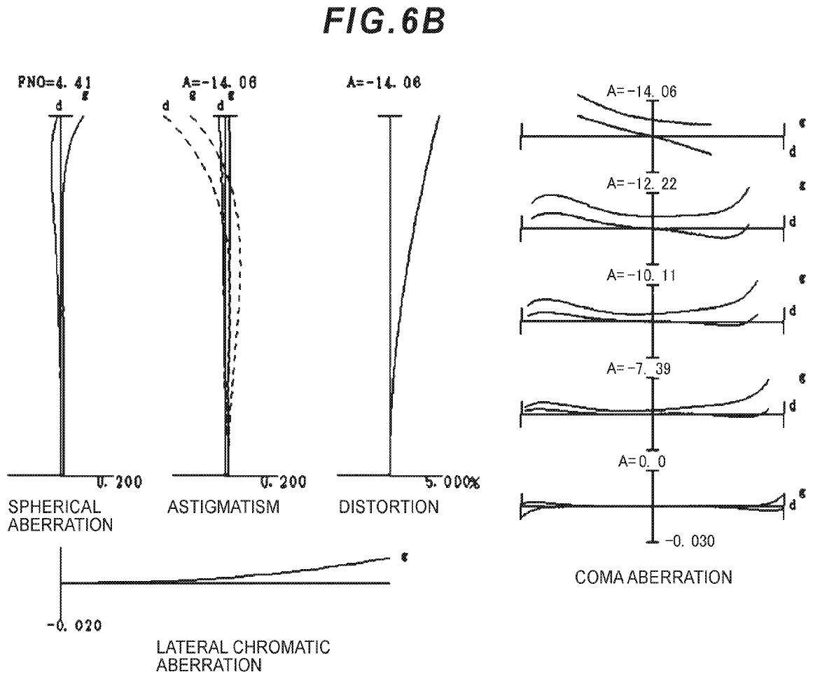

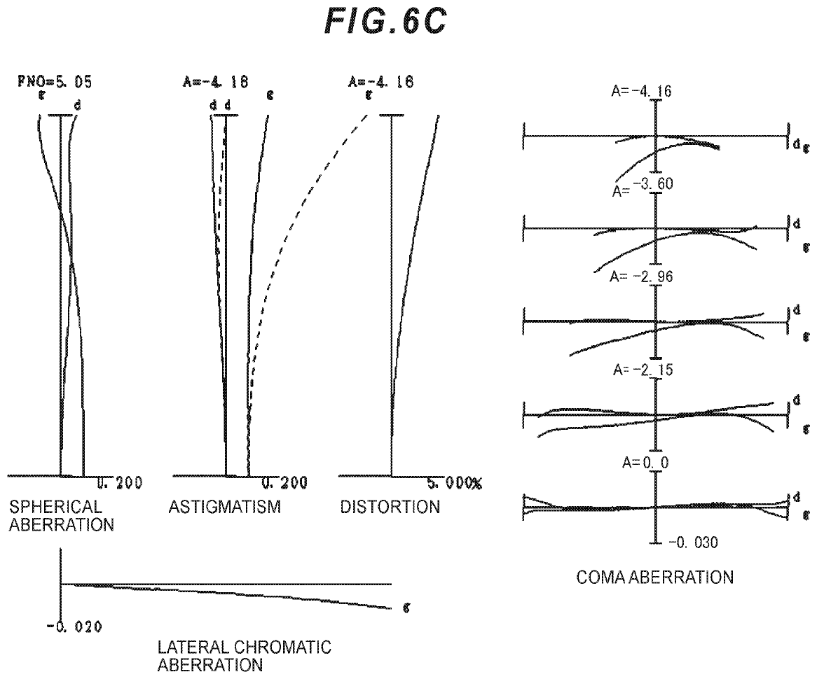

Example 3 is described with reference to FIG. 5, FIGS. 6A-6C, and Table 3. As illustrated in FIG. 5, an zoom lens ZL (ZL3) according to Example 3 includes: a first lens group G1 having positive refractive power; a second lens group G2 having negative refractive power; a third lens group G3 having positive refractive power; a fourth lens group G4 having negative refractive power; and a fifth lens group G5 having positive refractive power which are disposed in order from an object.

The first lens group G1 includes: a cemented lens including a negative meniscus lens L11 having a concave surface facing the image side and a biconvex lens L12; and a positive meniscus lens L13 having a convex surface facing the object side, which are disposed in order from the object.

The second lens group G2 includes: a negative meniscus lens L21 having a concave surface facing the image side; a biconcave lens L22; and a positive meniscus lens L23 having a convex surface facing the object side, which are disposed in order from an object. The negative meniscus lens L21 has an aspherical surface on the image side.

The third lens group G3 includes: a biconvex lens L31; a cemented lens including a biconvex lens L32 and a biconcave lens L33; and a biconvex lens L34, which are disposed in order from an object. The biconvex lens L31 has aspherical surfaces on both sides.

The fourth lens group G4 includes a negative meniscus lens L41 having a concave surface facing the image side. The negative meniscus lens L41 has an aspherical surface on the image side.

The fifth lens group G5 includes a negative meniscus lens L51 having a concave surface facing the object side and a positive meniscus lens L52 having a convex surface facing the image side which are arranged in order from an object. The negative meniscus lens L51 has an aspherical surface on the object side.

An aperture stop S, for adjusting the amount of light, is provided adjacent to and more on the object side than the third lens group G3.

A filter FL is disposed adjacent to and more on the image side than the fifth lens group G5. The filter FL includes a lowpass filter and an infrared cut filter for cutting the spatial frequency overwhelming the resolution limit of a solid-state image sensor such as a CCD provided on the image surface I.

The zoom lens ZL3 according to the present example performs zooming by changing the distances among the lens groups. Specifically, upon zooming from the wide angle end state to the telephoto end state, the first lens group G1 is moved toward the object side, the second lens group G2 is moved toward the image side, the third lens group G3 is moved toward the object side, the fourth lens group G4 is moved toward the object side and then moved toward the image side, and the fifth lens group G5 is moved toward the image side. The aperture stop S integrally moves with the third lens group G3 toward the object side.

In Table 3 below, specification values in Example 3 are listed.

Surface numbers 1 to 29 in Table 3 respectively correspond to the optical surfaces m1 to m29 in FIG. 5.

TABLE 3
[Lens specifications]

| Surface | | | | |
|---|---|---|---|---|
| number | R | D | νd | nd |
| 1 | 103.1998 | 2.0000 | 32.35 | 1.850260 |
| 2 | 42.2142 | 5.8000 | 81.73 | 1.497000 |
| 3 | −144.7935 | 0.2000 | | |
| 4 | 35.2068 | 3.8000 | 65.44 | 1.603000 |
| 5 | 156.5989 | (D5 = Variable) | | |
| 6 | 8344.1451 | 1.2000 | 42.71 | 1.820800 |
| *7 | 9.9754 | 3.8697 | | |
| 8 | −14.8375 | 1.0000 | 63.34 | 1.618000 |
| 9 | 34.6118 | 0.2000 | | |
| 10 | 24.3454 | 2.4000 | 17.98 | 1.945950 |
| 11 | 3333.2226 | (D11 = Variable) | | |
| 12 | 0.0000 | 1.0000 | | |
| *13 | 11.0527 | 3.2000 | 63.86 | 1.618810 |
| *14 | −41.7350 | 0.2000 | | |
| 15 | 15.7222 | 2.7000 | 81.73 | 1.497000 |
| 16- | 1000.0000 | 0.8000 | 35.25 | 1.910820 |
| 17 | 8.9784 | 0.5000 | | |
| 18 | 11.4409 | 2.8000 | 70.31 | 1.487490 |
| 19 | −17.8506 | (D19 = Variable) | | |
| 20 | 39.0430 | 0.7000 | 81.49 | 1.497100 |
| *21 | 10.7269 | (D21 = Variable) | | |
| *22 | −14.9604 | 0.7000 | 24.06 | 1.821150 |
| 23 | −21.9912 | 0.2000 | | |
| 24 | −206.5968 | 3.8000 | 52.34 | 1.755000 |
| 25 | −14.6758 | (D25 = Variable) | | |
| 26 | 0.0000 | 0.4700 | 63.88 | 1.516800 |
| 27 | 0.0000 | 0.1500 | | |
| 28 | 0.0000 | 0.7000 | 63.88 | 1.516800 |
| 29 | 0.0000 | (Bf) | | |

[Aspherical surface data]
7th surface
K = 1.4093
A4 = −5.27382E−05
A6 = −7.28271E−07
A8 = 0.00000E+00
13th surface
K = 0.4203
A4 = −7.50100E−06
A6 = 3.99816E−07
A8 = 1.35754E−09
14th surface
K = 1.0000
A4 = 9.24271E−05
A6 = 9.04859E−08
A8 = 0.00000E+00
21th surface
K = 1.0000
A4 = 3.92026E−05
A6 = −2.03642E−07
A8 = 0.00000E+00
22th surface
K = 1.0000
A4 = 6.47188E−05
A6 = 0.00000E+00
A8 = 0.00000E+00
[Various data]
Zooming rate 11.90

| | Wide angle | Intermediate | Telephoto |
|---|---|---|---|
| f | 9.05000 | 31.22000 | 107.63000 |
| FNO | 2.85 | 4.41 | 5.05 |
| ω | 42.13 | 14.06 | 4.16 |
| D5 | 0.99975 | 18.25533 | 35.86199 |
| D11 | 20.19099 | 8.81696 | 0.97403 |
| D19 | 1.51084 | 6.17130 | 9.31125 |
| D21 | 8.20011 | 17.35028 | 18.17086 |
| D25 | 7.76782 | 3.56874 | 0.99666 |
| Bf | 1.28000 | 1.28000 | 1.28000 |
| TL | 78.33927 | 93.83236 | 104.98453 |
| Exit pupil position | −76.93680 | 323.54769 | 198.91556 |
| G4 image surface | −1.14189 | −1.87267 | −2.02072 |
| movement coefficient | | | |
| (Upon focusing on infinity) | | | |

[Lens group data]

| Group | Group starting | Group focal |
|---|---|---|
| number | surface | length |
| G1 | 1 | 59.93130 |
| G2 | 6 | −9.36319 |
| G3 | 13 | 13.93321 |
| G4 | 20 | −30.00000 |
| G5 | 22 | 29.00000 |

[Conditional expression corresponding value]
Conditional expression (1) f5/d4w = 3.537
Conditional expression (2) TLt × f3/(ft × ft) = 0.126
Conditional expression (3) ft × ft/{(−f4) × d3t} = 41.517
Conditional expression (4) ωt = 4.16
Conditional expression (5) ωw = 42.13
Conditional expression (6) f1/(fw × ft) ^{1/2} = 1.920
Conditional expression (7) f4/(fw × ft) ^{1/2} = 0.961
Conditional expression (8) Dm5/(fw × ft) ^{1/2} = 0.217
Conditional expression (9) −f2/ft = 0.087
Conditional expression (10) D5/ft = 0.044
Conditional expression (11) (−Dm4)/ft = 0.094

It can be seen in Table 3 that the zoom lens ZL3 according to Example 3 satisfies the conditional expressions (1) to (11).

FIGS. 6A, 6B, and 6C are various aberration graphs (a spherical aberration graph, an astigmatism graph, a distortion graph, a coma aberration graph, and a lateral chromatic aberration graph) of the zoom lens ZL3 according to Example 3 upon focusing on infinity with FIG. 6A corresponding to the wide angle end state, FIG. 6B corresponding to the intermediate focal length state, and FIG. 6C corresponding to the telephoto end state.

It can be seen in the aberration graphs in FIGS. 6A, 6B, and 6C that the zoom lens ZL3 according to Example 3 can achieve an excellent imaging performance with various aberrations successfully corrected from the wide angle end state to the telephoto end state.

### EXAMPLE 4

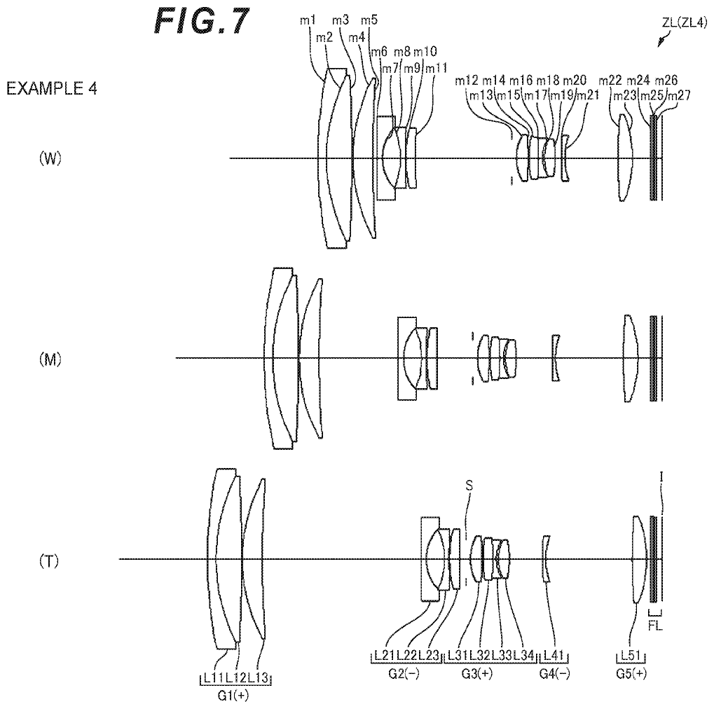

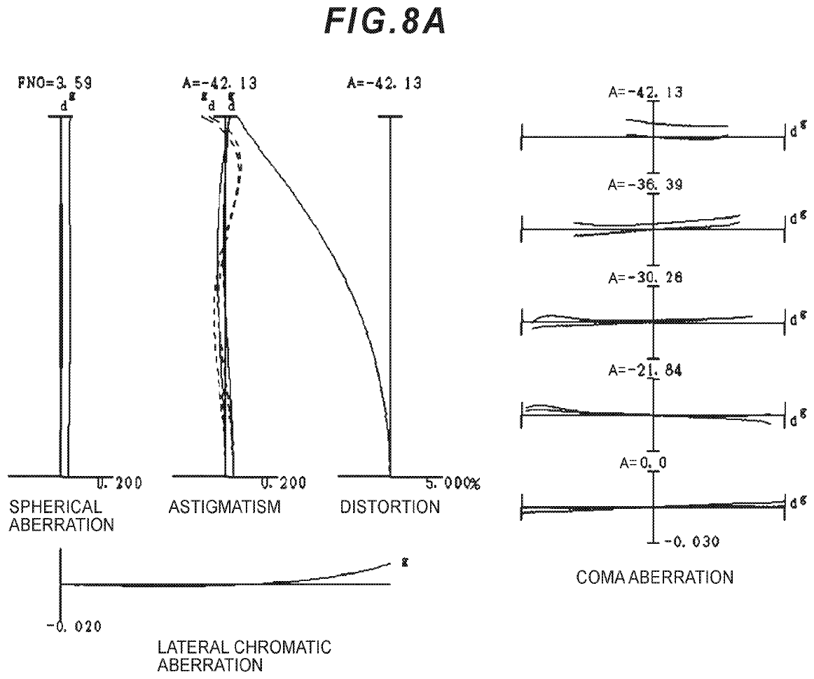

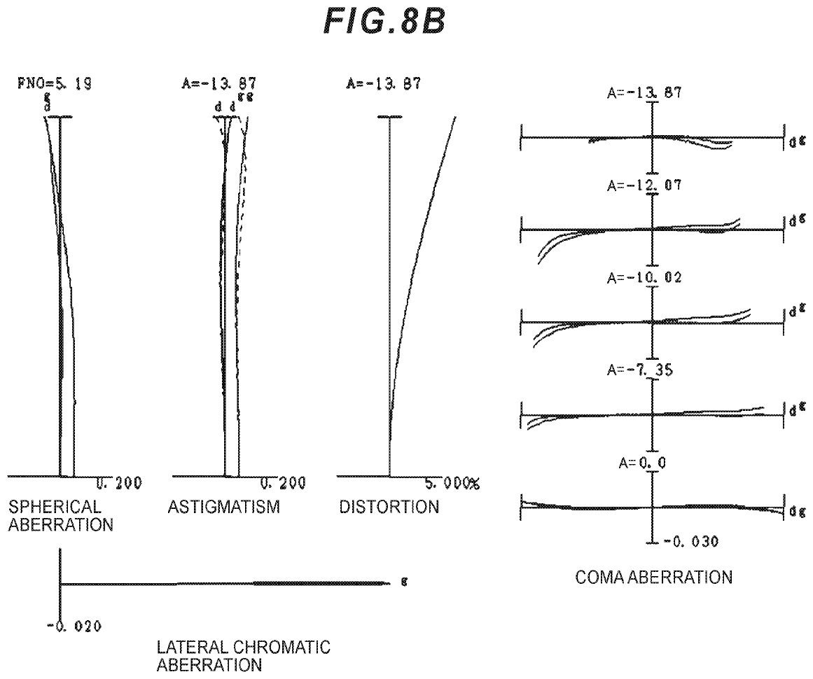

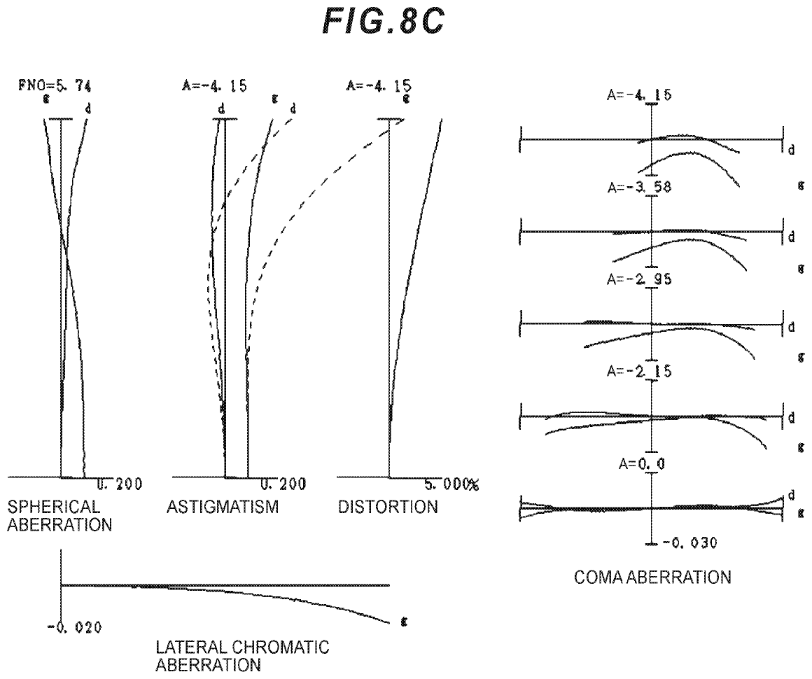

Example 4 is described with reference to FIG. 7, FIGS. 8A-8C, and Table 4. As illustrated in FIG. 7, a zoom lens ZL (ZL4) according to Example 4 includes: a first lens group G1 having positive refractive power; a second lens group G2 having negative refractive power; a third lens group G3 having positive refractive power; a fourth lens group G4 having negative refractive power; and a fifth lens group G5 having positive refractive power which are disposed in order from an object.

The first lens group G1 includes: a cemented lens including a negative meniscus lens L11 having a concave surface facing the image side and a biconvex lens L12; and a positive meniscus lens L13 having a convex surface facing the object side, which are disposed in order from the object.

The second lens group G2 includes: a biconcave lens L21; a biconcave lens L22; and a positive meniscus lens L23 having a convex surface facing the object side which are arranged in order from an object. The biconcave lens L21 has an aspherical surface on the image side.

The third lens group G3 includes: a biconvex lens L31; a cemented lens including a biconvex lens L32 and a biconcave lens L33; and a biconvex lens L34, which are disposed in order from an object. The biconvex lens L31 has aspherical surfaces on both sides.

The fourth lens group G4 includes a negative meniscus lens L41 having a concave surface facing the image side. The negative meniscus lens L41 has an aspherical surface on the image side.

The fifth lens group G5 includes a biconvex lens L51. The biconvex lens L51 has aspherical surfaces on the object side.

An aperture stop S, for adjusting the amount of light, is provided adjacent to and more on the object side than the third lens group G3.

A filter FL is disposed adjacent to and more on the image side than the fifth lens group G5. The filter FL includes a lowpass filter and an infrared cut filter for cutting the spatial frequency overwhelming the resolution limit of a solid-state image sensor such as a CCD provided on the image surface I.

The zoom lens ZL4 according to the present example performs zooming by changing the distances among the lens groups. Specifically, upon zooming from the wide angle end state to the telephoto end state, the first lens group G1 is moved toward the object side, the second lens group G2 is moved toward the image side, the third lens group G3 is moved toward the object side, the fourth lens group G4 is moved toward the object side, and the fifth lens group G5 is moved toward the image side. The aperture stop S integrally moves with the third lens group G3 toward the object side.

In Table 4 below, specification values in Example 4 are listed. Surface numbers 1 to 27 in Table 4 respectively correspond to the optical surfaces m1 to m27 in FIG. 7.

TABLE 4
[Lens specifications]

| Surface | | | | |
|---|---|---|---|---|
| number | R | D | νd | nd |
| 1 | 79.8804 | 2.0000 | 35.73 | 1.902650 |
| 2 | 35.0803 | 5.8000 | 81.73 | 1.497000 |
| 3 | −301.4041 | 0.2000 | | |
| 4 | 32.5517 | 4.5000 | 65.44 | 1.603000 |
| 5 | 205.2803 | (D5Variable) | | |
| 6 | −954.8817 | 1.2000 | 45.46 | 1.801390 |
| *7 | 8.5747 | 4.1517 | | |
| 8 | −14.5792 | 1.0000 | 65.44 | 1.603000 |
| 9 | 100.0656 | 0.2000 | | |
| 10 | 25.8431 | 2.2000 | 17.98 | 1.945950 |
| 11 | 669.0937 | (D11 = Variable) | | |
| 12 | 0.0000 | 1.0000 | | |
| *13 | 8.8052 | 2.7000 | 55.48 | 1.696800 |
| *14 | −35.0925 | 0.2000 | | |
| 15 | 21.5007 | 2.2000 | 81.73 | 1.497000 |
| 16 | −39.3286 | 0.8000 | 35.25 | 1.910820 |
| 17 | 6.9715 | 0.5000 | | |
| 18 | 9.0203 | 2.4000 | 70.31 | 1.487490 |
| 19 | −20.8115 | (D19Variable) | | |
| 20 | 109.9034 | 0.7000 | 81.49 | 1.497100 |
| *21 | 13.1034 | (D21 = Variable) | | |
| *22 | 66.8446 | 3.3000 | 63.86 | 1.618810 |
| 23 | −22.9208 | (D23Variable) | | |
| 24 | 0.0000 | 0.4700 | 63.88 | 1.516800 |
| 25 | 0.0000 | 0.1500 | | |
| 26 | 0.0000 | 0.7000 | 63.88 | 1.516800 |
| 27 | 0.0000 | (Bf) | | |

[Aspherical surface data]
7th surface
K = 1.1062
A4 = −5.47187E−05
A6 = −2.04034E−07
A8 = 0.00000E+00
13th surface
K = 1.4224
A4 = −1.69472E−04
A6 = −1.46252E−06
A8 = −1.40635E−08
14th surface
K = 1.0000
A4 = 1.30671E−04
A6 = −4.78933E−07
A8 = 3.42870E−08
21th surface
K = 1.0000
A4 = 2.58575E−05
A6 = 6.46545E−07
A8 = −4.56018E−08
22th surface
K = 1.0000
A4 = −4.97075E−05
A6 = 2.11919E−07
A8 = 0.00000E+00
[Various data]
Zooming rate 11.90

| | Wide angle | Intermediate | Telephoto |
|---|---|---|---|
| f | 9.05000 | 31.22000 | 107.63000 |
| FNO | 3.59 | 5.19 | 5.74 |
| ω | 42.13 | 13.87 | 4.15 |
| D5 | 1.00020 | 17.94742 | 36.02206 |
| D11 | 21.86565 | 8.23890 | 1.46641 |
| D19 | 1.50034 | 8.23008 | 7.62385 |
| D21 | 12.07988 | 15.43330 | 19.58032 |
| D23 | 4.18090 | 2.97206 | 1.00695 |
| Bf | 1.28000 | 1.28000 | 1.28000 |
| TL | 78.27867 | 90.47346 | 103.35129 |
| Exit pupil position | −82.58509 | −973.07845 | 277.08493 |
| G4 image surface | −1.18488 | −1.42536 | −1.80649 |
| movement coefficient | | | |
| (Upon focusing on infinity) | | | |

[Lens group data]

| Group | Group starting | Group focal |
|---|---|---|
| number | surface | length |
| G1 | 1 | 58.57487 |
| G2 | 6 | −9.29335 |
| G3 | 13 | 13.91463 |
| G4 | 20 | −30.00000 |
| G5 | 22 | 27.97540 |

[Conditional expression corresponding value]
Conditional expression (1) f5/d4w = 2.316
Conditional expression (1) TLt × f3/(ft × ft) = 0.124
Conditional expression (1) ft × ft/{(−f4) × d3t} = 50.649
Conditional expression (1) ωt = 4.15
Conditional expression (1) ωw = 42.13
Conditional expression (1) f1/(fw × ft) ^{1/2} = 1.877
Conditional expression (1) f4/(fw × ft) ^{1/2} = 0.961
Conditional expression (1) Dm5/(fw × ft) ^{1/2} = 0.102
Conditional expression (1) −f2/ft = 0.086
Conditional expression (1) D5/ft = 0.031
Conditional expression (1) (−Dm4)/ft = 0.040

It can be seen in Table 4 that the zoom lens ZL4 according to Example 4 satisfies the conditional expressions (1) to (11).

FIGS. 8A, 8B, and 8C are various aberration graphs (a spherical aberration graph, an astigmatism graph, a distortion graph, a coma aberration graph, and a lateral chromatic aberration graph) of the zoom lens ZL4 according to Example 4 upon focusing on infinity with FIG. 8A corresponding to the wide angle end state, FIG. 8B corresponding to the intermediate focal length state, and FIG. 8C corresponding to the telephoto end state.

It can be seen in the aberration graphs in FIGS. 8A, 8B, and 8C that the zoom lens ZL4 according to Example 4 can achieve an excellent imaging performance with various aberrations successfully corrected from the wide angle end state to the telephoto end state.

With the Examples according to the 1st embodiment described above, a zoom lens having a small size with an exit pupil position sufficiently distant from the image surface, and having high optical performance can be achieved.

Elements of the 1st embodiments are described above to facilitate the understanding of the present invention. It is a matter of course that the present invention is not limited to these. The following configurations can be appropriately employed without compromising the optical performance of the zoom lens according to the present application.

The numerical values of the configuration with the five groups are described as an example of values of the zoom lens ZL according to the 1st embodiment. However, this should not be construed in a limiting sense, and the present invention can be applied to a configuration with other number of groups (for example, six groups or the like). More specifically, a configuration further provided with a lens or a lens group closest to an object or further provided with a lens or a lens group closest to the image may be employed. The lens group is a portion including at least one lens separated from another lens with a distance varying upon zooming or focusing.

In the zoom lens ZL according to the 1st embodiment may have the following configuration. Specifically, upon focusing on a short-distant object from infinity, part of the lens groups of the first lens group G1 to the fifth lens group G5, one entire lens group, or a plurality of lens groups may be moved in the optical axis direction as the focusing lens group. The focusing lens group may be applied to auto focusing, and can be suitably driven by a motor (such as an ultrasonic motor for example) for auto focusing. The fourth lens group G4 is especially preferably used as the focusing lens group. The focusing may be performed with the fourth lens group G4 and the fifth lens group G5 simultaneously moved in an optical axis direction. The focusing may also be performed with the entire zoom lens ZL moved in the optical axis direction.

In the zoom lens ZL according to the 1st embodiment, the entire lens group of or part of any of the first lens group G1 to the fifth lens group G5 may be moved with a component in a direction orthogonal to the optical axis, or may be moved and rotated (swing) within an in-plane direction including the optical axis, to serve as the vibration-proof lens group for correcting image blur due to camera shake or the like.

In the zoom lens ZL according to the 1st embodiment, the lens surface may be formed to have a spherical surface or a planer surface, or may be formed to have an aspherical shape. The lens surface having a spherical surface or a planer surface features easy lens processing and assembly adjustment, which leads to the processing and assembly adjustment less likely to involve an error compromising the optical performance, and thus is preferable. Furthermore, there is an advantage that a rendering performance is not largely compromised even when the image surface is displaced. The lens surface having an aspherical shape may be achieved with any one of an aspherical shape formed by grinding, a glass-molded aspherical shape obtained by molding a glass piece into an aspherical shape, and a composite type aspherical surface obtained by providing an aspherical shape resin piece on a glass surface. A lens surface may be a diffractive surface. The lens may be a gradient index lens (GRIN lens) or a plastic lens.

In the zoom lens ZL according to the 1st embodiment, the aperture stop S is preferably disposed in the neighborhood of the third lens group G3. Alternatively, a lens frame may serve as the aperture stop so that the member serving as the aperture stop needs not to be provided.

In the zoom lens ZL according to the 1st embodiment, the lens surfaces may be provided with an antireflection film featuring high transmittance over a wide range of wavelengths to achieve an excellent optical performance with reduced flare and ghosting and increased contrast.

### Description of the Embodiments

### 2nd Embodiment

In the description below, a 2nd embodiment is described with reference to drawings. As illustrated in FIG. 12, a zoom lens ZL according to the 2nd embodiment includes a first lens group G1 having positive refractive power, a second lens group G2 having negative refractive power, a third lens group G3 having positive refractive power, a fourth lens group G4 having negative refractive power, and a fifth lens group G5 having positive refractive power, which are disposed in order from an object. Upon zooming from a wide angle end state to a telephoto end state, the fifth lens group G5 is moved toward an image side.

With such a configuration, a lens with a high zooming rate can be implemented.

The zoom lens ZL according to the 2nd embodiment having the configuration described above satisfies the following conditional expressions (12) and (13).

1.96<f1/(fw×ft)^{1/2}<2.80 (12)

0.67<f4/(fw×ft)^{1/2}<2.10 (13)

where,

f1 denotes a focal length of the first lens group G1,

f4 denotes a focal length of the fourth lens group G4,

fw denotes a focal length of the zoom lens ZL in the wide angle end state, and

ft denotes a focal length of the zoom lens ZL in the telephoto end state.

The conditional expression (12) is for setting a focal length of the first lens group G1. A spherical aberration and variation of aberration due to zooming can be reduced, when the conditional expression (12) is satisfied.

A value higher than the upper limit value of the conditional expression (12) leads to small refractive power of the first lens group G1, resulting in a large lens movement amount upon zooming and thus a large total length. Furthermore, the refractive power of the other lens groups increases, rendering various aberrations, such as curvature of field, in the telephoto end state difficult to correct.

To guarantee the effects of the 2nd embodiment, the upper limit value of the conditional expression (12) is preferably set to be 2.50.

A value lower than the lower limit value of the conditional expression (12) leads to large refractive power of the first lens group G1, rendering various aberrations, such as spherical aberration and curvature of field, in the telephoto end state difficult to correct.

To guarantee the effects of the 2nd embodiment, the lower limit value of the conditional expression (12) is preferably set to be 2.10.

The conditional expression (13) is for setting a focal length of the fourth lens group G4.

A value higher than the upper limit value of the conditional expression (13) renders various aberrations, such as curvature of field, difficult to correct.

To guarantee the effects of the 2nd embodiment, the upper limit value of the conditional expression (13) is preferably set to be 1.70.

A value lower than the lower limit value of the conditional expression (13) renders various aberrations, such as curvature of field, difficult to correct.

To guarantee the effects of the 2nd embodiment, the lower limit value of the conditional expression (13) is preferably set to be 0.75.

The zoom lens ZL according to the 2nd embodiment preferably has the distances among the lens groups changing upon zooming from the wide angle end state to the telephoto end state.

With such a configuration, a lens with a high zooming rate can be implemented.

The zoom lens ZL according to the 2nd embodiment preferably has the distance between the first lens group G1 and the second lens group G2 increasing and the distance between the second lens group G2 and the third lens group G3 decreasing upon zooming from the wide angle end state to the telephoto end state.

With such a configuration, a lens with a high zooming rate and excellent optical performance can be implemented.

In the zoom lens ZL according to the 2nd embodiment, the first lens group G1 preferably moves upon zooming from the wide angle end state to the telephoto end state.

With such a configuration, a lens with a high zooming rate and excellent optical performance can be implemented.

The zoom lens ZL according to the 2nd embodiment preferably satisfies the following conditional expression (14).

0.120<Dm5/(fw×ft)^{1/2}<0.270 (14)

where,

Dm5 denotes a difference in the position of the fifth lens group G5 on the optical axis between the wide angle end state and the telephoto end state (with a value increasing in accordance with displacement toward the image side).

The conditional expression (14) is for setting a movement amount of the fifth lens group G5.

A value higher than the upper limit value of the conditional expression (14) renders various aberrations, such as curvature of field, in the wide angle end state difficult to correct.

To guarantee the effects of the 2nd embodiment, the upper limit value of the conditional expression (14) is preferably set to be 0.24.

A value lower than the lower limit value of the conditional expression (14) renders various aberrations, such as curvature of field, difficult to correct.

To guarantee the effects of the 2nd embodiment, the lower limit value of the conditional expression (14) is preferably set to be 0.16.

The zoom lens ZL according to the 2nd embodiment preferably satisfies the following conditional expression (15).

0.052<(−f2)/ft<0.150 (15)

where,

f2 denotes a focal length of the second lens group G2.

The conditional expression (15) is for setting relationship between the focal length of the second lens group G2 and the focal length of the zoom lens ZL in the telephoto end state. A spherical aberration and variation of aberration due to zooming can be reduced, when the conditional expression (15) is satisfied.

A value higher than the upper limit value of the conditional expression (15) leads to excessively small refractive power of the second lens group G2, resulting in larger refractive power of the other lens groups, rendering various aberrations, such as spherical aberration and curvature of field, difficult to correct. Furthermore, the movement amount of the second lens group G2 increases, leading to a larger optical total length and a large front lens diameter, rendering downsizing difficult.

To guarantee the effects of the 2nd embodiment, the upper limit value of the conditional expression (15) is preferably set to be 0.24.

A value lower than the lower limit value of the conditional expression (15) leads to excessively large refractive power of the second lens group G2, rendering various aberrations, such as astigmatism and curvature of field, difficult to correct.

To guarantee the effects of the 2nd embodiment, the lower limit value of the conditional expression (15) is preferably set to be 0.16.

The zoom lens ZL according to the 2nd embodiment preferably satisfies the following conditional expression (16).

0.020<D5/ft<0.050 (16)

where,

D5 denotes a thickness of the fifth lens group G5 on the optical axis.

The conditional expression (16) is for setting relationship between the thickness of the fifth lens group G5 on the optical axis and the focal length of the zoom lens ZL in the telephoto end state.

A value higher than the upper limit value of the conditional expression (16) results in an increase in the thickness of the fifth lens group G5 on the optical axis. An attempt to maintain distances among the groups renders various aberrations, such as a coma aberration, difficult to correct.

To guarantee the effects of the 2nd embodiment, the upper limit value of the conditional expression (16) is preferably set to be 0.041.

A value lower than the lower limit value of the conditional expression (16) leads to a small thickness of the fifth lens group G5 on the optical axis and small refractive power of the fifth lens group

G5, rendering various aberrations, such as curvature of field, difficult to correct.

To guarantee the effects of the 2nd embodiment, the lower limit value of the conditional expression (16) is preferably set to be 0.025.

The zoom lens ZL according to the 2nd embodiment preferably satisfies the following conditional expression (17).

0.005<(−Dm4)/ft<0.080 (17)

where,

Dm4 denotes a difference in a position of the fourth lens group G4 on the optical axis between the wide angle end state and the telephoto end state (with a value increasing in accordance with displacement toward the image side).

The conditional expression (17) is for setting a movement amount of the fourth lens group G4.

A value higher than the upper limit value of the conditional expression (17) renders various aberrations, such as curvature of field and lateral chromatic aberration, difficult to correct, when the refractive power of the other lens groups is increased to maintain the entire optical length.

To guarantee the effects of the 2nd embodiment, the upper limit value of the conditional expression (17) is preferably set to be 0.075. To more effectively guarantee the effects of the 2nd embodiment, the upper limit value of the conditional expression (17) is preferably set to be 0.070.

A value lower than the lower limit value of the conditional expression (17) renders various aberrations, such as spherical aberration and on-axis chromatic aberration, difficult to correct.

To guarantee the effects of the 2nd embodiment, the lower limit value of the conditional expression (17) is preferably set to be 0.005.

In the zoom lens ZL according to the 2nd embodiment, the third lens group G3 preferably includes at least one aspherical lens.

With this configuration, various aberrations such as spherical aberration can be successfully corrected.

The zoom lens ZL according to the 2nd embodiment preferably satisfies the following conditional expression (18).

1.00°<ωt<7.50° (18)

where,

ωt denotes a half angle of view in the telephoto end state.

The conditional expression (18) is for setting an optimum value of an angle of view in the telephoto end state. Various aberrations, such as a coma aberration, distortion, and curvature of field, can be successfully corrected, when the conditional expression (18) is satisfied.

To guarantee the effects of the 2nd embodiment, the upper limit value of the conditional expression (18) is preferably set to be 7.00°. To more effectively guarantee the effects of the 2nd embodiment, the upper limit value of the conditional expression (18) is preferably set to be 6.00°.

To guarantee the effects of the 2nd embodiment, the lower limit value of the conditional expression (18) is preferably set to be 2.00°.

The zoom lens ZL according to the 2nd embodiment preferably satisfies the following conditional expression (19).

32.00°<ωw<47.00° (19)

where,

ωw denotes a half angle of view in the wide angle end state.

The conditional expression (19) is for setting an optimum value of an angle of view in the wide angle end state. Various aberrations, such as a coma aberration, distortion, and curvature of field, can be successfully corrected while guaranteeing a wide angle of view, when the conditional expression (19) is satisfied.

To guarantee the effects of the 2nd embodiment, the upper limit value of the conditional expression (19) is preferably set to be 45.00°.

To guarantee the effects of the 2nd embodiment, the lower limit value of the conditional expression (19) is preferably set to be 33.00°. To more effectively guarantee the effects of the 2nd embodiment, the lower limit value of the conditional expression (19) is preferably set to be 34.00°.

With the zoom lens ZL according to the 2nd embodiment having the configuration described above, a zoom lens having a high zooming rate, and having high optical performance can be achieved.

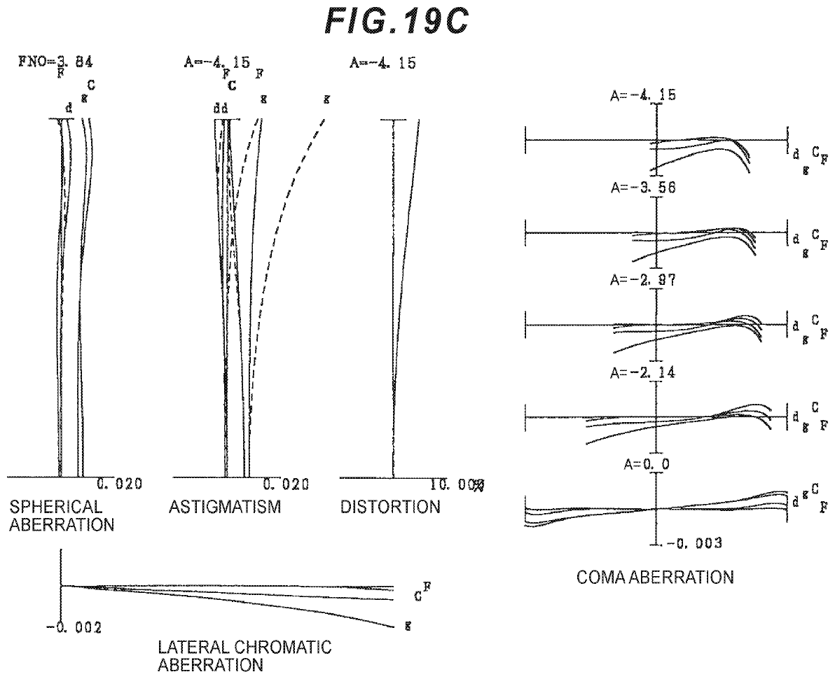

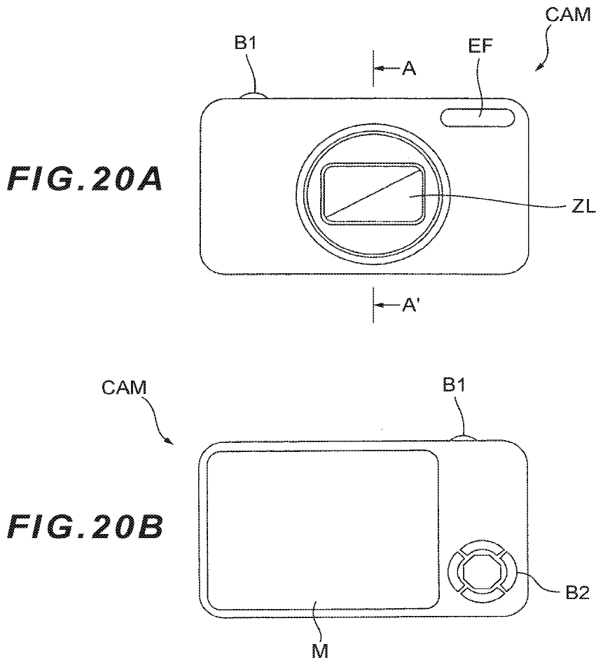

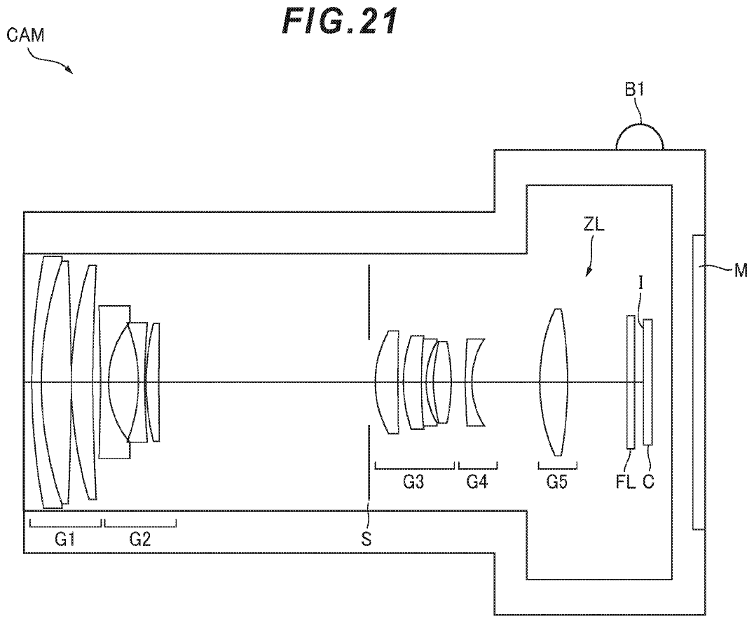

FIGS. 20A and 20B, and FIG. 21 illustrate a configuration of a digital still camera CAM (optical apparatus) that is an optical apparatus including the zoom lens ZL according to the 2nd embodiment. When a power button (not illustrated) is pressed, in the digital still camera CAM, a shutter (not illustrated) of an imaging lens (the zoom lens ZL) opens. Thus, light from a subject (object) is focused by the zoom lens ZL and formed on an image sensor C (such as a CCD or a CMOS for example) disposed on an image surface I (see FIG. 1). A subject image thus formed on the image sensor C is displayed on a liquid crystal monitor M provided on a back side of the digital still camera CAM. A photographer determines a composition of the subject image while viewing the liquid crystal monitor M, and thus presses down a release button B1 to capture the subject image with the image sensor C. The image is recorded and stored in a memory (not illustrated). The photographer can capture an image of a subject with the camera CAM in the manner described above.

The camera CAM further includes: an auxiliary light emitting unit EF that emits auxiliary light when a subject is dark; and a function button B2 used for setting various conditions of the digital still camera CAM.

In this example, a compact type camera with the camera CAM and the zoom lens ZL integrally formed is described. The optical apparatus may also be a single-lens reflex camera with a lens barrel including the zoom lens ZL and a camera body that can be detachably attached to each other.

With the camera CAM according to the 2nd embodiment having the configuration described above including the zoom lens ZL according to the 2nd embodiment serving as the imaging lens, a camera having a high zooming rate, and having high optical performance can be achieved.

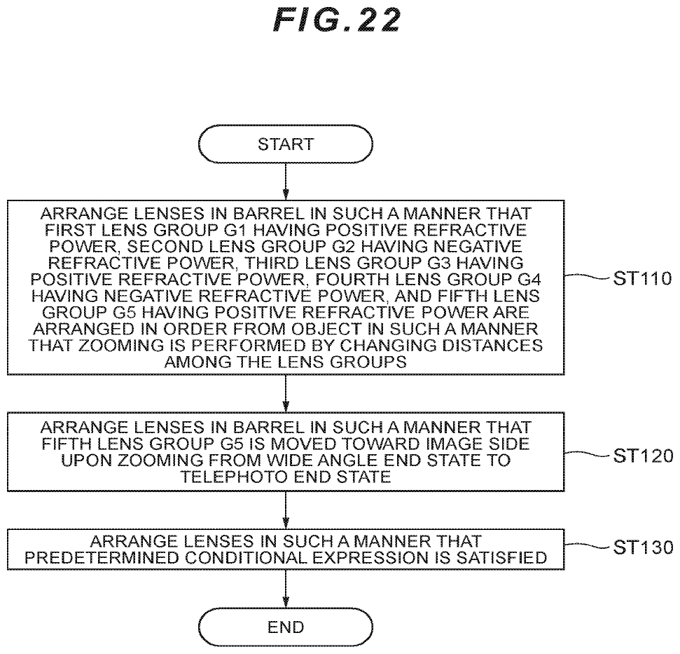

Next, a method for manufacturing the zoom lens ZL according to the 2nd embodiment is described with reference to FIG. 22. First of all, the lenses are arranged in a barrel in such a manner that the first lens group G1 having positive refractive power, the second lens group G2 having negative refractive power, the third lens group G3 having positive refractive power, the fourth lens group G4 having negative refractive power, and the fifth lens group G5 having positive refractive power are arranged in order from the object in such a manner that zooming is performed by changing the distances among the lens groups (step ST110). The lenses are arranged in such a manner that the fifth lens group G5 is moved toward the image side upon zooming from the wide angle end state to the telephoto end state (step ST120). The lenses are arranged in such a manner that the following conditional expressions (12) and (13) are satisfied (step ST130).

1.96<f1/(fw×ft)^{1/2}<2.80 (12)

0.67<f4/(fw×ft)^{1/2}<2.10 (13)

where,

f1 denotes a focal length of the first lens group G1,

f4 denotes a focal length of the fourth lens group G4,

fw denotes a focal length of the zoom lens ZL in the wide angle end state, and

ft denotes a focal length of the zoom lens ZL in the telephoto end state.

An example of the lens arrangement according to the 2nd embodiment is described. Specifically, as illustrated in FIG. 12, the first to the fifth lens groups G1-G5 are disposed in order from the object. The first lens group G1 includes: a cemented lens including a negative meniscus lens L11 having a concave surface facing the image side and a positive lens L12 having a biconvex shape; and a positive meniscus lens L13 having a convex surface facing the object side, disposed in order from the object. The second lens group G2 includes: a negative lens L21 having a biconcave shape; a negative lens L22 having a biconcave shape; and a positive meniscus lens L23 having a convex surface facing the object side, disposed in order from the object. The third lens group G3 includes: a positive lens L31 having a biconvex shape; a cemented lens including a positive meniscus lens L32 having a convex surface facing the object side and a negative meniscus lens L33 having a concave surface facing the image side; and a positive lens L34 having a biconvex shape disposed in order from the object. The fourth lens group G4 includes a negative meniscus lens L41 having a concave surface facing the image side. The fifth lens group G5 includes a positive lens L51 having a biconvex shape. The zoom lens ZL is manufactured by arranging lens groups thus prepared in the manner described above.

With the manufacturing method according to the 2nd embodiment as described above, the zoom lens ZL having a high zooming rate, and having high optical performance can be manufactured.

### Example According to 2nd Embodiment

Examples according to the 2nd embodiment are described with reference to the drawings. FIGS. 12, 14, 16, and 18 are cross-sectional views illustrating configurations and refractive power distributions of zoomlenses ZL (ZL5 to ZL8) according to Examples. Each cross-sectional view illustrates the positions of the lens groups in a process of zooming from the wide angle end state (W) to the telephoto end state (T).

Reference signs in FIG. 12 corresponding to Example 5 are independently provided for each Example, to avoid complication of description due to increase in the number of digits of the reference signs. Thus, reference signs that are the same as those in a drawing corresponding to another Example do not necessarily indicate a configuration that is the same as that in the other Example.

Table 5 to Table 8 described below are specification tables of Examples 5 to 8.

In Examples, d-line (wavelength 587.6 nm), g-line (wavelength 435.8 nm), a C-line (wavelength 656.3 nm), and an F-line (wavelength 486.1 nm) are selected as calculation targets of the aberration characteristics.

In [Lens specifications] in the tables, a surface number represents an order of an optical surface from the object side in a traveling direction of a light beam, R represents a radius of curvature of each optical surface, D represents a distance between each optical surface and the next optical surface (or the image surface) on the optical axis, nd represents a refractive index of a material of an optical member with respect to the d-line, and vd represents Abbe number of the material of the optical member based on the d-line. Furthermore, obj surface represents an object surface, Di represents a distance between an ith surface and an (i+1) th surface, (stop S) represents the aperture stop S, Bf represents back focus (a distance between a lens last surface and a paraxial image surface on the optical axis), and img surface represents the image surface I. Furthermore, “∞” and “0.00000” of a radius of curvature represents a plane or an aperture. The refractive index “1.000000” of air is omitted. An aspherical optical surface has a * mark in the field of surface number and has a paraxial radius of curvature in the field of radius of curvature R.

In the table, [Aspherical surface data] has the following formula (b) indicating the shape of an aspherical surface in [Lens specifications]. In the formula, X(y) represents a distance between the tangent plane at the vertex of the aspherical surface and a position on the aspherical surface at a height y along the optical axis direction, R represents a radius of curvature (paraxial radius of curvature) of a reference spherical surface, κ represents a conical coefficient, and Ai represents an ith aspherical coefficient. In the formula, “E−n” represents “×10⁻ⁿ”. For example, 1.234E−05=1.234×10⁻⁵. A secondary aspherical coefficient A2 is 0, and thus is omitted.

X(y)=(y²/R)/{1+(1−κ×y²/R²)^{1/2}}A4×y⁴+A6×y⁶+A8×y⁸+A10×y¹⁰ (b)

Specifically, in [Overall specifications] in the tables, f represents a focal length of the whole zoom lens, FNo represents F number, ω represents a half angle of view (unit: °), TL represents optical total length (the distance between the lens forefront surface and the paraxial image surface on the optical axis), and Bf represents back focus (a distance between a lens last surface and a paraxial image surface on the optical axis).

In the tables, [Zooming data] includes the surface distance Di in the wide-angle end state, the intermediate focal length state, and the telephoto end state. Note that Di represents the distance between the ith surface and the (i+1)th surface.

In [Zoom lens group data] in the tables, G represents a group number, group starting surface indicates the number of the surface closest to the object in each group, group focal length represents the focal length of each group, and lens configuration length represents the distance on the optical axis between the lens surface closest to the object and the lens surface closest to the image in each group.

In [Conditional expression] in the tables, values corresponding to the conditional expressions (12) to (19) are described.

The focal length f, the radius of curvature R, the surface distance D and the other units of length described below as all the specification values, which are generally described with “mm” unless otherwise noted should not be construed in a limiting sense because the optical system proportionally expanded or reduced can have a similar or the same optical performance. The unit is not limited to “mm”, and other appropriate units may be used.

The description on the tables described above commonly applies to all Examples 5 to 8, and thus will not be described below.

### EXAMPLE 5

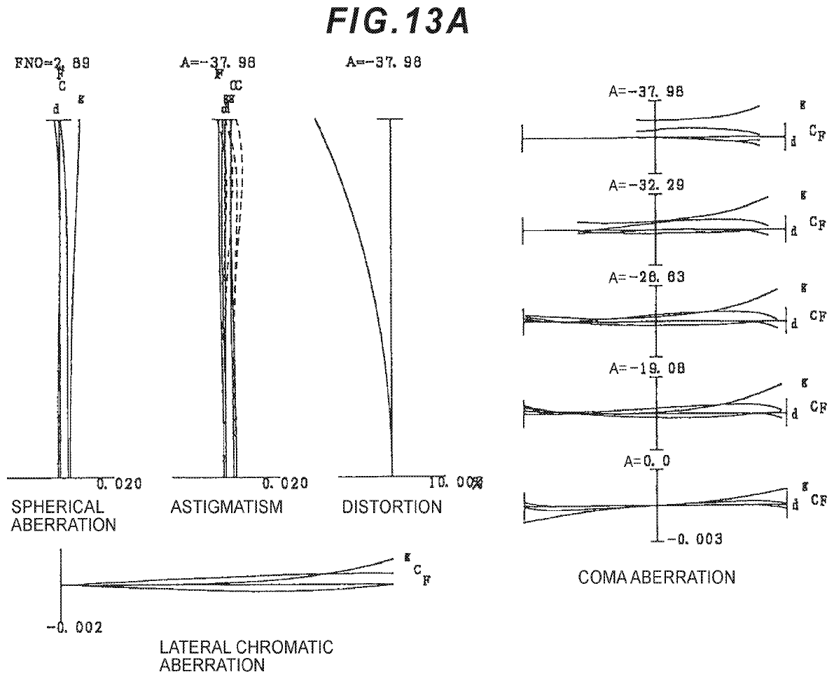

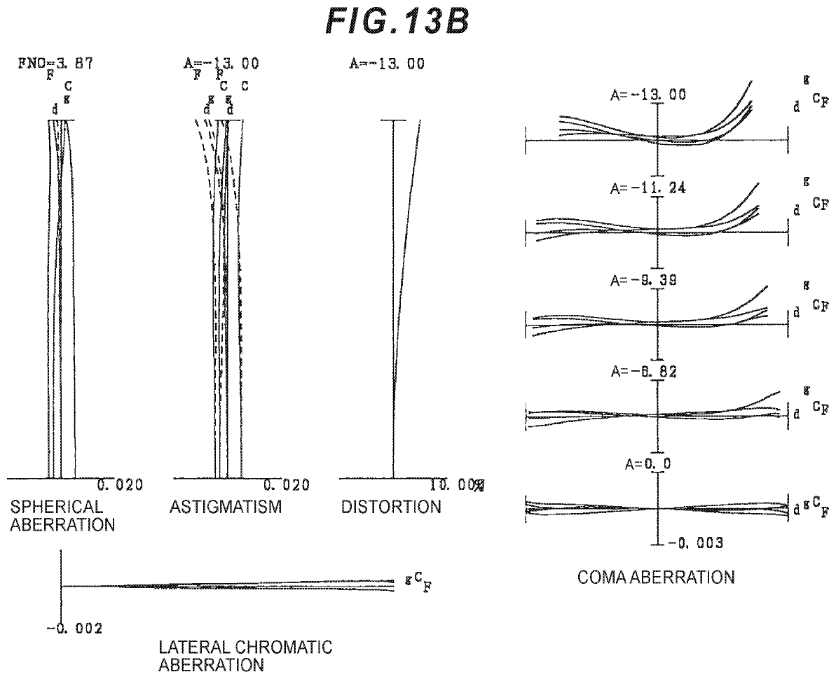

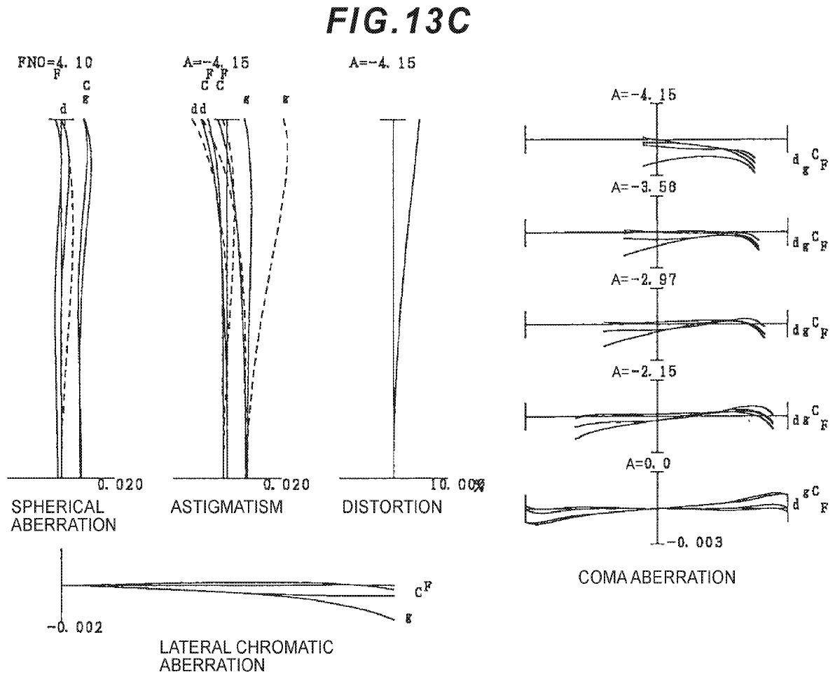

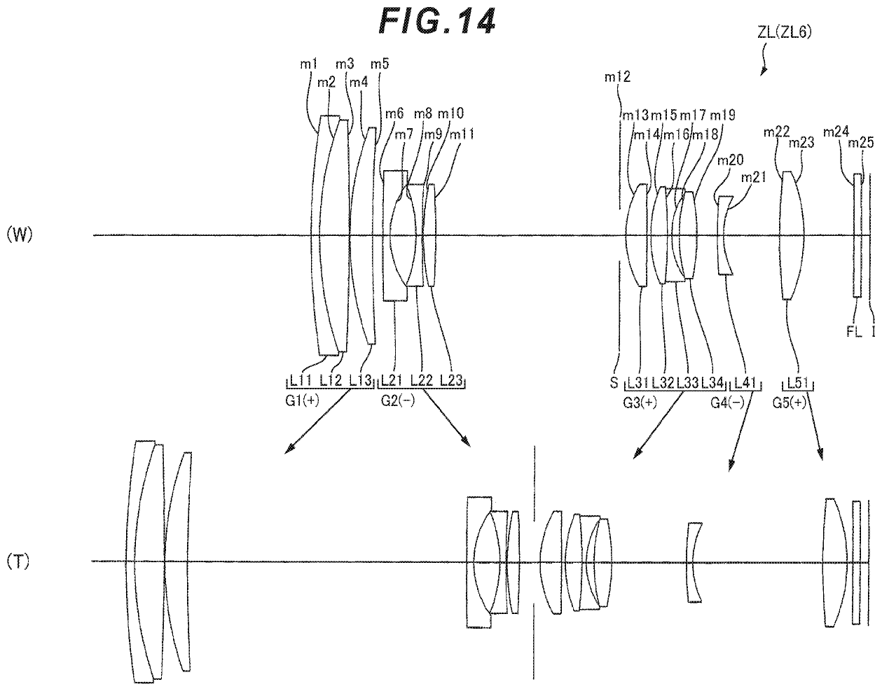

Example 5 is described with reference to FIG. 12, FIGS. 13A-13C, and Table 5. As illustrated in FIG. 12, a zoom lens ZL (ZL5) according to Example 5 includes: a first lens group G1 having positive refractive power; a second lens group G2 having negative refractive power; a third lens group G3 having positive refractive power; a fourth lens group G4 having negative refractive power; and a fifth lens group G5 having positive refractive power which are disposed in order from an object.

The first lens group G1 includes: a cemented lens including a negative meniscus lens L11 having a concave surface facing the image side and a positive lens L12 having a biconvex shape; and a positive meniscus lens L13 having a convex surface facing the object side, which are disposed in order from the object.

The second lens group G2 includes: a negative lens L21 having a biconcave shape; a negative lens L22 having a biconcave shape; and a positive meniscus lens L23 having a convex surface facing the object side which are disposed in order from an object. The negative lens L21 having a biconcave shape has an aspherical surface on the image side.

The third lens group G3 includes: a positive lens L31 having a biconvex shape; a cemented lens including a positive meniscus lens L32 having a convex surface facing the object side and a negative meniscus lens L33 having a concave surface facing the image side; and a positive lens L34 having a biconvex shape arranged in order from the object. The positive lens L31 having a biconvex shape has aspherical surfaces on both of the object side and the image side.

The fourth lens group G4 includes a negative meniscus lens L41 having a concave surface facing the image side. The negative meniscus lens L41 has an aspherical surface on the image side.

The fifth lens group G5 includes a positive lens L51 having a biconvex shape. The positive lens L51 having a biconvex shape has an aspherical surface on the object side.

An aperture stop S, for determining the brightness, is provided adjacent to and more on the object side than the third lens group G3.

A filter group FL is provided between the fifth lens group G5 and the image surface I. The filter group FL includes a glass block such as a lowpass filter and an infrared cut filter for cutting the spatial frequency overwhelming the resolution limit of a solid-state imaging device such as a CCD provided on the image surface I.

The zoom lens ZL5 according to the present example moves all the five lens groups G1 to G5 in such a manner that upon zooming from the wide angle end state to the telephoto end state, a distance between the first lens group G1 and the second lens group G2 increases, a distance between the second lens group G2 and the third lens group G3 decreases, a distance between the third lens group G3 and the fourth lens group G4 changes, and a distance between the fourth lens group G4 and the fifth lens group G5 increases. Specifically, upon zooming, the first lens group G1 is moved toward the object side, the second lens group G2 is moved toward the image side, the third lens group G3 is moved toward the object side, the fourth lens group G4 is moved toward the image side and then moved toward the object side, and the fifth lens group G5 is moved toward the image side. The aperture stop S integrally moves with the third lens group G3 toward the object side upon zooming.

In Table 5 below, specification values in Example 5 are listed. Surface numbers 1 to 25 in Table 5 respectively correspond to the optical surfaces m1 to m25 in FIG. 12.

TABLE 5
[Lens specifications]

| Surface | | | | |
|---|---|---|---|---|
| number | R | D | nd | νd |
| Obj | ∞ | | | |
| surface | | | | |
| 1 | 8.89769 | 0.13208 | 1.795040 | 28.69 |
| 2 | 4.70388 | 0.42925 | 1.497000 | 81.73 |
| 3 | −31.96674 | 0.00943 | | |
| 4 | 5.03309 | 0.31132 | 1.603000 | 65.44 |
| 5 | 30.43269 | D5(Variable) | | |
| 6 | −18.42636 | 0.11321 | 1.772500 | 49.49 |
| *7 | 1.22318 | 0.42925 | | |
| 8 | −2.05202 | 0.09434 | 1.622990 | 58.12 |
| 9 | 10.31827 | 0.01887 | | |
| 10 | 3.18337 | 0.18396 | 1.945950 | 17.98 |
| 11 | 66.33739 | D11(Variable) | | |
| 12 | ∞ | 0.09434 | (Stop S) | |
| *13 | 1.32166 | 0.33019 | 1.693500 | 53.22 |
| *14 | −12.40396 | 0.07547 | | |
| 15 | 1.89257 | 0.25943 | 1.497000 | 81.73 |
| 16 | 5.87646 | 0.06604 | 1.784720 | 25.64 |
| 17 | 1.05410 | 0.10377 | | |
| 18 | 2.05301 | 0.25943 | 1.487490 | 70.31 |
| 19 | −2.27354 | D19(Variable) | | |
| 20 | 7.30761 | 0.09434 | 1.553320 | 71.67 |
| *21 | 1.13060 | D21(Variable) | | |
| *22 | 2.51284 | 0.40566 | 1.618810 | 63.86 |
| 23 | −4.69410 | D23(Variable) | | |
| 24 | 0.00000 | 0.11038 | 1.516800 | 63.88 |
| 25 | 0.00000 | Bf | | |
| Img | ∞ | | | |
| surface | | | | |

[Aspherical surface data]
7th surface
K = 0.0000,A4 = −1.49952E−02,A6 = −3.16087E−03,A8 = 0.00000E+00,
A10 = 0.00000E+00
13th surface
K = 0.0000,A4 = −3.17644E−02,A6 = 0.00000E+00,A8 = 0.00000E+00,
A10 = 0.00000E+00
14th surface
K = 0.0000,A4 = 5.13219E−02,A6 = 0.00000E+00,A8 = 0.00000E+00,
A10 = 0.00000E+00
21th surface
K = 0.0000,A4 = 0.00000E+00,A6 = −1.62856E−02,A8 = −1.21206E−02,
A10 = 0.00000E+00
22th surface
K = 0.0000,A4 = −2.28761E−04,A6 = 1.25152E−02,A8 = 0.00000E+00,
A10 = 0.00000E+00
[Overall specifications]
Zooming rate 10.015094

| | Wide angle | | Telephoto |
|---|---|---|---|
| | end | Intermediate | end |
| f | 1.00000 | 3.18605 | 10.015094 |
| FNo | 2.88705 | 3.87123 | 4.09587 |
| ω | 37.97787 | 13.00106 | 4.15018 |
| TL | 8.81848 | 8.92665 | 11.21378 |
| Bf | 0.13487 | 0.13487 | 0.13488 |

[Zooming data]

| | Wide angle | | Telephoto |
|---|---|---|---|
| | end | Intermediate | end |
| D5 | 0.11164 | 1.71345 | 4.15984 |
| D11 | 3.02327 | 0.79251 | 0.22933 |
| D19 | 0.20518 | 1.23512 | 0.85812 |
| D21 | 0.97206 | 0.86800 | 1.99592 |
| D23 | 0.85069 | 0.66195 | 0.31493 |

[Zoom lens group data]

| | Group | Group | Lens |
|---|---|---|---|
| Group | starting | focal | configuration |
| number | surface | length | length |
| G1 | 1 | 7.09770 | 0.88208 |
| G2 | 6 | −1.31403 | 0.83962 |
| G3 | 13 | 1.66449 | 1.09434 |
| G4 | 20 | −2.43052 | 0.09434 |
| G5 | 22 | 2.70306 | 0.40566 |

[Conditional expression]
Conditional expression (12) f1/(fw × ft) ^{1/2} = 2.228
Conditional expression (13) f4/(fw × ft) ^{1/2} = 0.763
Conditional expression (14) Dm5/(fw × ft) ^{1/2} = 0.168
Conditional expression (15) −f2/ft = 0.129
Conditional expression (16) D5/ft = 0.040
Conditional expression (17) (−Dm4)/ft = 0.048
Conditional expression (18) ωt = 4.15018
Conditional expression (19) ωw = 37.97787

It can be seen in Table 5 that the zoom lens ZL5 according to Example 5 satisfies the conditional expressions (12) to (19).

FIGS. 13A, 13B, and 13C are various aberration graphs (a spherical aberration graph, an astigmatism graph, a distortion graph, a coma aberration graph, and a lateral chromatic aberration graph) of the zoom lens ZL5 according to Example 5 upon focusing on infinity with FIG. 13A corresponding to the wide angle end state, FIG. 13B corresponding to the intermediate focal length state, and FIG. 13C corresponding to the telephoto end state.

In the aberration graphs, FNO represents an F number, A represents a half angle of view (unit: °), and d, g, C, and F respectively represent aberrations on the d-line, the g-line, the C-line, and the F-line. Those denoted with none of the above represent aberrations on the d-line. In an aberration graph, a solid line represents a spherical aberration, and a broken line represents a sine condition. In an astigmatism graph, a solid line represents a sagittal image surface, and a broken line represents a meridional image surface. In a coma aberration graph, a solid line represents a meridional coma. The lateral chromatic aberration graph is illustrated based on the d-line. In aberration graphs in Examples described below, the same reference signs as in this Example are used.

It can be seen in the aberration graphs in FIGS. 13A, 13B, and 13C that the zoom lens ZL5 according to Example 5 can achieve an excellent imaging performance with various aberrations successfully corrected from the wide angle end state to the telephoto end state.

### EXAMPLE 6

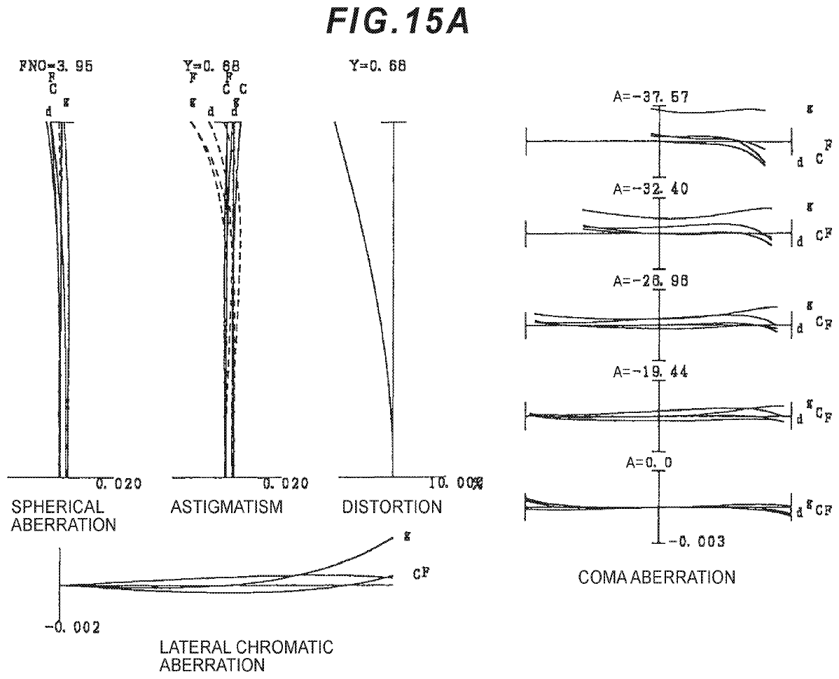

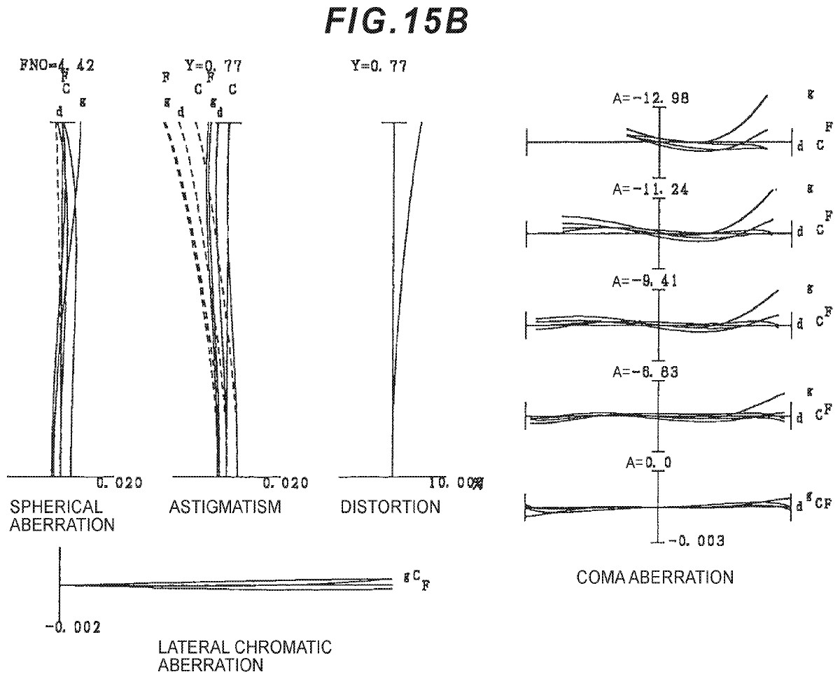

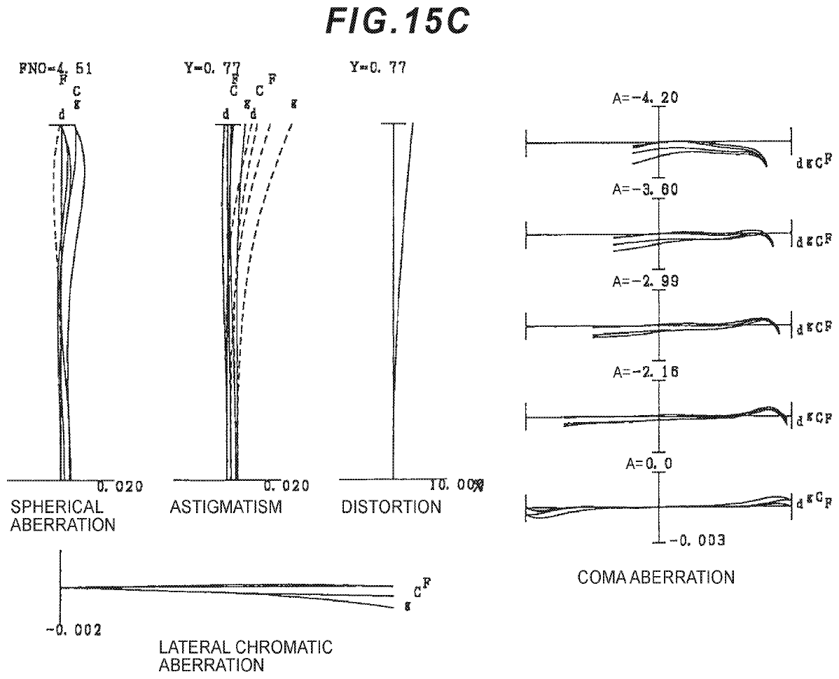

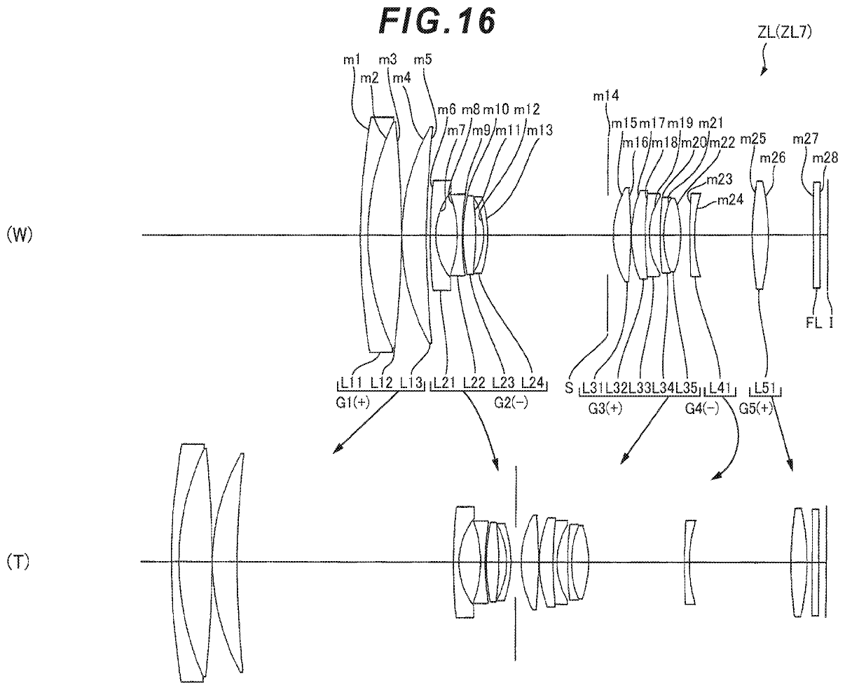

Example 6 is described with reference to FIG. 14, FIGS. 15A-15C, and Table 6. As illustrated in FIG. 14, a zoom lens ZL (ZL6) according to Example 6 includes: a first lens group G1 having positive refractive power; a second lens group G2 having negative refractive power; a third lens group G3 having positive refractive power; a fourth lens group G4 having negative refractive power; and a fifth lens group G5 having positive refractive power which are disposed in order from an object.

The first lens group G1 includes: a cemented lens including a negative meniscus lens L11 having a concave surface facing the image side and a positive lens L12 having a biconvex shape; and a positive meniscus lens L13 having a convex surface facing the object side, which are disposed in order from the object.

The second lens group G2 includes: a negative meniscus lens L21 having a concave surface facing the image side; a negative lens L22 having a biconcave shape; and a positive lens L23 having a biconvex shape, which are disposed in order from the object. The negative lens L22 having a biconcave shape has aspherical surfaces on both of the object side and the image side.

The third lens group G3 includes: a positive lens L31 having a biconvex shape; a cemented lens including a positive lens L32 having a biconvex shape and a negative lens L33 having a biconcave shape; and a positive lens L34 having a biconvex shape, which are disposed in order from an object. The positive lens L31 having a biconvex shape has aspherical surfaces on both of the object side and the image side.

The fourth lens group G4 includes a negative meniscus lens L41 having a concave surface facing the image side. The negative meniscus lens L41 has an aspherical surface on the image side.

The fifth lens group G5 includes a positive lens L51 having a biconvex shape. The positive lens L51 having a biconvex shape has an aspherical surface on the object side.

An aperture stop S, for determining the brightness, is provided adjacent to and more on the object side than the third lens group G3.

A filter group FL is provided between the fifth lens group G5 and the image surface I. The filter group FL includes a glass block such as a lowpass filter and an infrared cut filter for cutting the spatial frequency overwhelming the resolution limit of a solid-state imaging device such as a CCD provided on the image surface I.

The zoom lens ZL6 according to the present example moves all the five lens groups G1 to G5 in such a manner that upon zooming from the wide angle end state to the telephoto end state, a distance between the first lens group G1 and the second lens group G2 increases, a distance between the second lens group G2 and the third lens group G3 decreases, a distance between the third lens group G3 and the fourth lens group G4 changes, and a distance between the fourth lens group G4 and the fifth lens group G5 increases. Specifically, upon zooming, the first lens group G1 is moved toward the object side, the second lens group G2 is moved toward the image side, the third lens group G3 is moved toward the object side, the fourth lens group G4 is moved toward the object side, and the fifth lens group G5 is moved toward the image side. The aperture stop S integrally moves with the third lens group G3 toward the object side upon zooming.

In Table 6 below, specification values in Example 6 are listed. Surface numbers 1 to 25 in Table 6 respectively correspond to the optical surfaces m1 to m25 in FIG. 14.

TABLE 6
[Lens specifications]

| Surface | | | | |
|---|---|---|---|---|
| number | R | D | nd | vd |
| Obj | ∞ | | | |
| surface | | | | |
| 1 | 10.48948 | 0.13208 | 1.850260 | 32.35 |
| 2 | 4.77283 | 0.45755 | 1.497000 | 81.73 |
| 3 | −44.21095 | 0.00943 | | |
| 4 | 4.32871 | 0.34906 | 1.603000 | 65.44 |
| 5 | 22.14886 | D5(Variable) | | |
| 6 | 33.20405 | 0.11321 | 1.799520 | 42.09 |
| 7 | 1.18686 | 0.40094 | | |
| *8 | −1.72595 | 0.09434 | 1.768020 | 49.23 |
| *9 | 17.68559 | 0.01887 | | |
| 10 | 3.43418 | 0.18868 | 1.945944 | 17.98 |
| 11 | −11.82097 | D11(Variable) | | |
| 12 | ∞ | 0.09434 | (Stop S) | |
| *13 | 1.35910 | 0.33019 | 1.693500 | 53.22 |
| *14 | −14.77673 | 0.05660 | | |
| 15 | 1.71011 | 0.25943 | 1.497000 | 81.73 |
| 16 | −6.50727 | 0.06604 | 1.688930 | 31.16 |
| 17 | 1.00973 | 0.11792 | | |
| 18 | 2.11806 | 0.27358 | 1.603000 | 65.44 |
| 19 | −2.81605 | D19(Variable) | | |
| 20 | 5.46298 | 0.09434 | 1.583130 | 59.44 |
| *21 | 1.10425 | D21(Variable) | | |
| *22 | 6.14744 | 0.37736 | 1.592010 | 67.05 |
| 23 | −2.14882 | D23(Variable) | | |
| 24 | 0.00000 | 0.11038 | 1.516800 | 63.88 |
| 25 | 0.00000 | Bf | | |
| Img | ∞ | | | |
| surface | | | | |

[Aspherical surface data]
8th surface
K = 0.0000,A4 = 2.50272E−02,A6 = 0.00000E+00,A8 = 0.00000E+00,
A10 = 0.00000E+00
9th surface
K = 0.0000,A4 = 2.45863E−02,A6 = 0.00000E+00,A8 = 0.00000E+00,
A10 = 0.00000E+00
13th surface
K = 0.0000,A4 = −2.18620E−02,A6 = 8.87111E−03,A8 = 0.00000E+00,
A10 = 0.00000E+00
14th surface
K = 0.0000,A.4 = 4.76381E−02,A6 = 2.17581E−03,A8 = 0.00000E+00,
A10 = 0.00000E+00
21th surface
K = 0.0000,A4 = 0.00000E+00,A6 = 7.51204E−03,A8 = −2.45863E−01,
A10 = 0.00000E+00
22th surface
K = 0.0000,A4 = −2.78834E−02,A6 = 6.18823E−03,A8 = 0.00000E+00,
A10 = 0.00000E+00
[Overall specifications]
Zooming rate 10.015094

| | Wide angle | | Telephoto |
|---|---|---|---|
| | end | Intermediate | end |
| f | 1.00000 | 3.18605 | 10.015094 |
| FNo | 3.95801 | 4.42171 | 4.50956 |
| ω | 37.57318 | 12.98250 | 4.19937 |
| TL | 8.62204 | 9.69400 | 11.31174 |
| Bf | 0.13481 | 0.13481 | 0.13470 |

[Zooming data]

| | Wide angle | | Telephoto |
|---|---|---|---|
| | end | Intermediate | end |
| D5 | 0.15727 | 2.17201 | 4.29591 |
| D11 | 2.84103 | 1.07226 | 0.22574 |
| D19 | 0.31295 | 0.94759 | 1.16038 |
| D21 | 0.85974 | 1.37340 | 1.99514 |
| D23 | 0.77190 | 0.44960 | 0.09024 |

[Zoom lens group data]

| | Group | Group | Lens |
|---|---|---|---|
| Group | starting | focal | configuration |
| number | surface | length | length |
| G1 | 1 | 7.65078 | 0.88208 |
| G2 | 6 | −1.28158 | 0.83962 |
| G3 | 13 | 1.61492 | 1.09434 |
| G4 | 20 | −2.39248 | 0.09434 |
| G5 | 22 | 2.73585 | 0.40566 |

[Conditional expression]
Conditional expression (12) f1/(fw × ft) ^{1/2} = 2.401
Conditional expression (13) f4/(fw × ft) ^{1/2} = 0.751
Conditional expression (14) Dm5/(fw × ft) ^{1/2} = 0.214
Conditional expression (15) −f2/ft = 0.126
Conditional expression (16) D5/ft = 0.037
Conditional expression (17) (−Dm4)/ft = 0.045
Conditional expression (18) ωt = 4.19937
Conditional expression (19) ωw = 37.57318

It can be seen in Table 6 that the zoom lens ZL6 according to Example 6 satisfies the conditional expressions (12) to (19).

FIGS. 15A, 15B, and 15C are various aberration graphs (a spherical aberration graph, an astigmatism graph, a distortion graph, a coma aberration graph, and a lateral chromatic aberration graph) of the zoom lens ZL6 according to Example 6 upon focusing on infinity with FIG. 15A corresponding to the wide angle end state, FIG. 15B corresponding to the intermediate focal length state, and FIG. 15C corresponding to the telephoto end state.

It can be seen in the aberration graphs in FIGS. 15A, 15B, and 15C that the zoom lens ZL6 according to Example 6 can achieve an excellent imaging performance with various aberrations successfully corrected from the wide angle end state to the telephoto end state.

### EXAMPLE 7

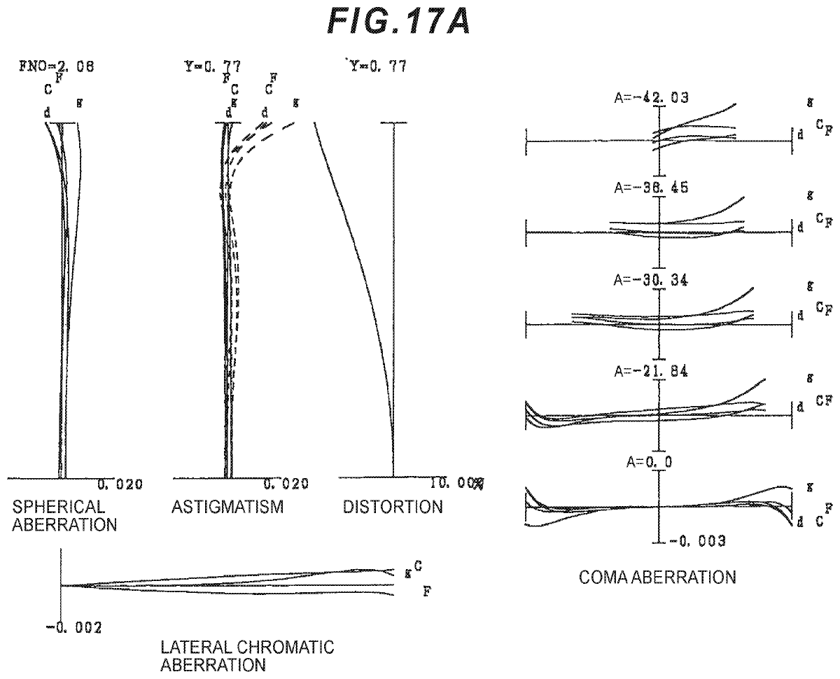

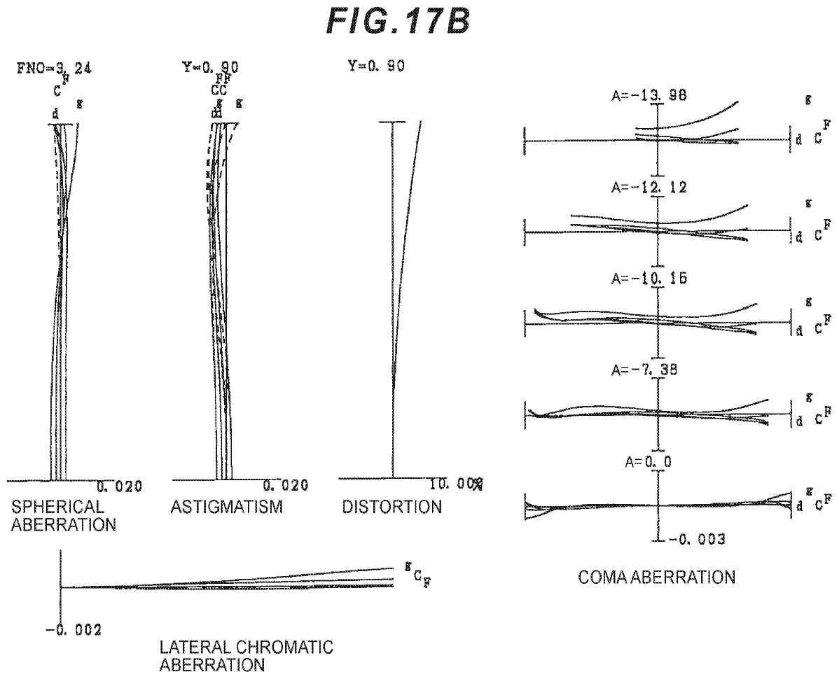

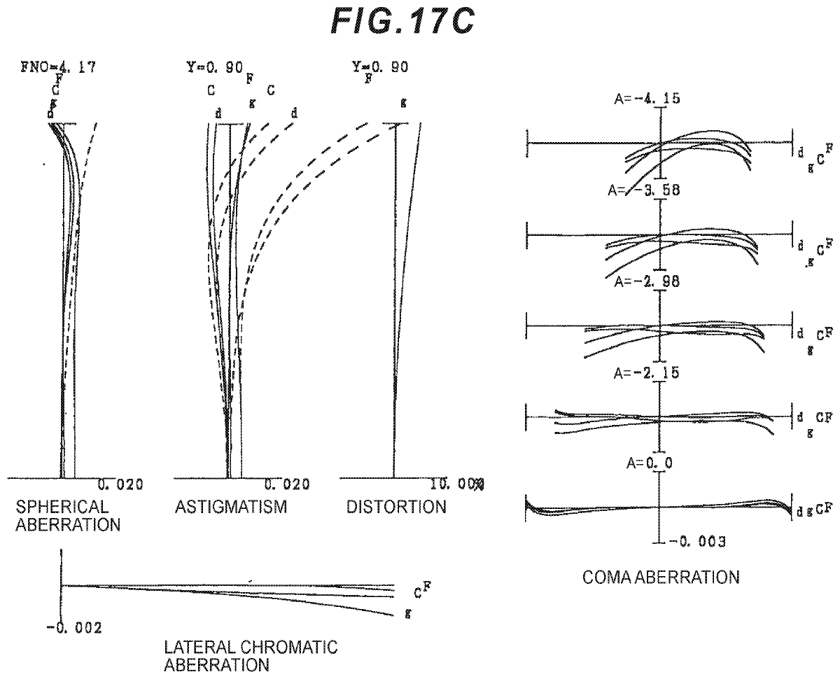

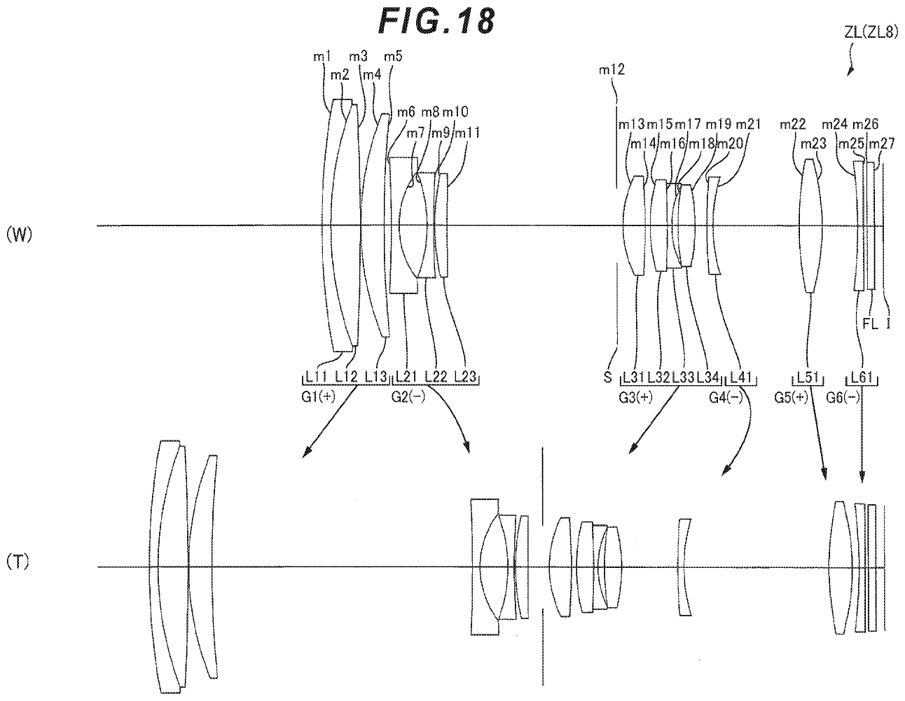

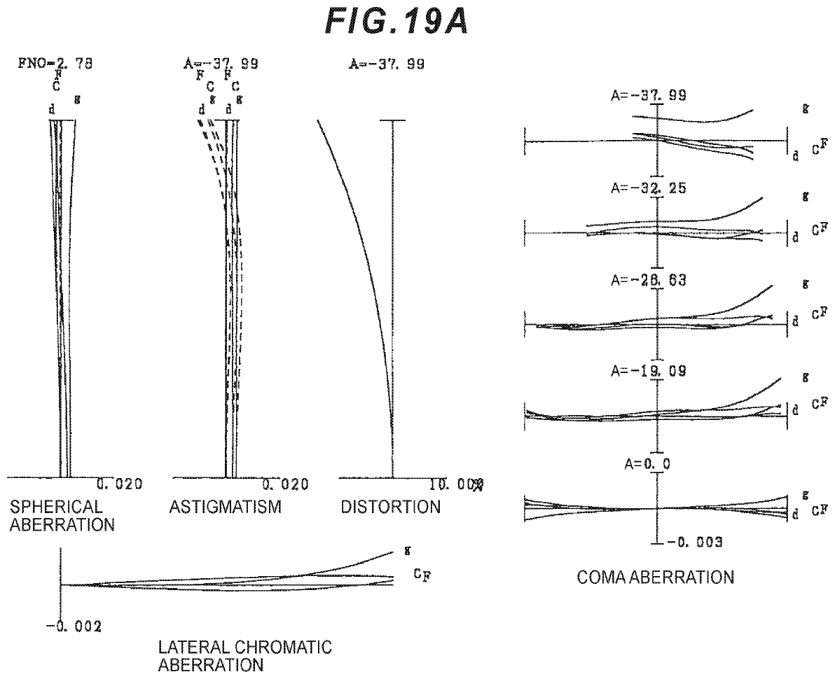

Example 7 is described with reference to FIG. 16, FIGS. 17A-17C, and Table 7. As illustrated in FIG. 16, a zoom lens ZL (ZL7) according to Example 7 includes: a first lens group G1 having positive refractive power; a second lens group G2 having negative refractive power; a third lens group G3 having positive refractive power; a fourth lens group G4 having negative refractive power; and a fifth lens group G5 having positive refractive power which are disposed in order from an object.

The first lens group G1 includes: a cemented lens including a negative meniscus lens L11 having a concave surface facing the image side and a positive lens L12 having a biconvex shape; and a positive meniscus lens L13 having a convex surface facing the object side, which are disposed in order from the object.

The second lens group G2 includes: a negative meniscus lens L21 having a concave surface facing the image side; a negative lens L22 having a biconcave shape; a positive lens L23 having a biconvex shape; and a negative meniscus lens L24 having a concave surface facing the object side, which are disposed in order from the object. The negative meniscus lens L21 has aspherical surfaces on both of the object side and the image side.

The third lens group G3 includes: a positive lens L31 having a. biconvex shape; a cemented lens including a positive meniscus lens L32 having a convex surface facing the object side and a negative meniscus lens L33 having a concave surface facing the image side; a cemented lens including a negative meniscus lens L34 having a concave surface facing the image side; and a positive lens L35 having a biconvex shape, which are disposed in order from the object. The positive lens L31 having a biconvex shape has aspherical surfaces on both of the object side and the image side.

The fourth lens group G4 includes a negative meniscus lens L41 having a concave surface facing the image side. The negative meniscus lens L41 has an aspherical surface on the image side.

The fifth lens group G5 includes a positive lens L51 having a biconvex shape. The positive lens L51 having a biconvex shape has an aspherical surface on the object side.

An aperture stop S, for determining the brightness, is provided adjacent to and more on the object side than the third lens group G3.

A filter group FL is provided between the fifth lens group G5 and the image surface I. The filter group FL includes a glass block such as a lowpass filter and an infrared cut filter for cutting the spatial frequency overwhelming the resolution limit of a solid-state imaging device such as a CCD provided on the image surface I.

The zoom lens ZL7 according to the present example moves all the five lens groups G1 to G5 in such a manner that upon zooming from the wide angle end state to the telephoto end state, a distance between the first lens group G1 and the second lens group G2 increases, a distance between the second lens group G2 and the third lens group G3 decreases, a distance between the third lens group G3 and the fourth lens group G4 changes, and a distance between the fourth lens group G4 and the fifth lens group G5 increases. Specifically, upon zooming, the first lens group G1 is moved toward the object side, the second lens group G2 is moved toward the image side, the third lens group G3 is moved toward the object side, the fourth lens group G4 is moved toward the image side and then moved toward the object side, and the fifth lens group G5 is moved toward the image side. The aperture stop S integrally moves with the third lens group G3 toward the object side upon zooming.

In Table 7 below, specification values in Example 7 are listed. Surface numbers 1 to 28 in Table 7 respectively correspond to the optical surfaces m1 to m28 in FIG. 16.

TABLE 7
[Lens specifications]

| Surface | | | | |
|---|---|---|---|---|
| number | R | D | nd | νd |
| Obj | ∞ | | | |
| surface | | | | |
| 1 | 12.44522 | 0.15453 | 1.910820 | 35.25 |
| 2 | 4.86090 | 0.68433 | 1.497000 | 81.73 |
| 3 | −17.94869 | 0.01104 | | |
| 4 | 4.01822 | 0.50773 | 1.603000 | 65.44 |
| 5 | 17.63829 | D5(Variable) | | |
| *6 | 13.14355 | 0.11038 | 1.851350 | 40.10 |
| *7 | 1.27623 | 0.44150 | | |
| 8 | −2.13976 | 0.09934 | 1.834810 | 42.73 |
| 9 | 4.65876 | 0.02208 | | |
| 10 | 3.43355 | 0.25386 | 1.945950 | 17.98 |
| 11 | −5.09851 | 0.16004 | | |
| 12 | −1.40459 | 0.08830 | 1.603000 | 65.44 |
| 13 | −2.14672 | D13(Variable) | | |
| 14 | ∞ | 0.11038 | (Stop S) | |
| *15 | 1.68325 | 0.36424 | 1.618810 | 63.86 |
| *16 | −5.55328 | 0.01104 | | |
| 17 | 2.14052 | 0.28698 | 1.603000 | 65.44 |
| 18 | 8.13453 | 0.07726 | 1.581440 | 40.98 |
| 19 | 1.31536 | 0.22075 | | |
| 20 | 6.12841 | 0.07726 | 1.755200 | 27.57 |
| 21 | 1.76906 | 0.35320 | 1.497000 | 81.73 |
| 22 | −1.96153 | D22(Variable) | | |
| 23 | 11.43749 | 0.09934 | 1.592010 | 67.05 |
| *24 | 2.60133 | D24(Variable) | | |
| *25 | 5.14219 | 0.33113 | 1.592010 | 67.05 |
| 26 | −4.33506 | D26(Variable) | | |
| 27 | 0.00000 | 0.12914 | 1.516800 | 63.88 |
| 28 | 0.00000 | Bf | | |
| Img | ∞ | | | |
| surface | | | | |

[Aspherical surface data]
6th surface
K = 0.0000,A4 = 1.23964E−02,A6 = 0.00000E+00,A8 = 0.00000E+00,
A10 = 0.00000E+00
7th surface
K = 0.0000,A4 = 5.79301E−03,A6 = 1.11989E−02,A8 = 0.00000E+00,
A10 = 0.00000E+00
15th surface
K = 0.0000,A4 = −2.11270E−02,A6 = 3.00468E−03,A8 = 0.00000E+00,
A10 = 0.00000E+00
16th surface
K = 0.0000,A4 = 4.55787E−02,A6 = 0.00000E+00,A8 = 0.00000E+00,
A10 = 0.00000E+00
24th surface
K = 0.0000,A4 = 3.72669E−03,A6 = 0.00000E+00,A8 = 0.00000E+00,
A10 = 0.00000E+00
25th surface
K = 0.0000,A4 = −2.03605E−02,A6 = 0.00000E+00,A8 = 0.00000E+00,
A10 = 0.00000E+00
[Overall specifications]
Zooming rate 11.87638

| | Wide angle | | Telephoto |
|---|---|---|---|
| | end | Intermediate | end |
| f | 1.00000 | 3.44621 | 11.87638 |
| FNo | 2.06367 | 3.24469 | 4.16656 |
| ω | 42.03372 | 13.97794 | 4.15396 |
| TL | 9.60800 | 11.33008 | 13.45283 |
| Bf | 0.15781 | 0.15781 | 0.15753 |

[Zooming data]

| | Wide angle | | Telephoto |
|---|---|---|---|
| | end | Intermediate | end |
| D5 | 0.08358 | 2.34920 | 4.43766 |
| D13 | 2.47156 | 0.83323 | 0.09697 |
| D22 | 0.18188 | 1.90634 | 1.97053 |
| D24 | 1.19277 | 1.01980 | 2.08540 |
| D26 | 0.92658 | 0.46989 | 0.11091 |

[Zoom lens group data]

| | Group | Group | Lens |
|---|---|---|---|
| Group | starting | focal | configuration |
| number | surface | length | length |
| G1 | 1 | 7.47345 | 1.35762 |
| G2 | 6 | −1.11498 | 1.17550 |
| G3 | 15 | 1.91694 | 1.50110 |
| G4 | 23 | −5.71153 | 0.09934 |
| G5 | 25 | 4.02542 | 0.33113 |

[Conditional expression]
Conditional expression (12) f1/(fw × ft) ^{1/2} = 2.169
Conditional expression (13) f4/(fw × ft) ^{1/2} = 1.657
Conditional expression (14) Dm5/(fw × ft) ^{1/2} = 0.237
Conditional expression (15) −f2/ft = 0.094
Conditional expression (16) D5/ft = 0.028
Conditional expression (17) (−Dm4)/ft = 0.069
Conditional expression (18) ωt = 4.15396
Conditional expression (19) ωw = 42.03372

It can be seen in Table 7 that the zoom lens ZL7 according to Example 7 satisfies the conditional expressions (12) to (19).

FIGS. 17A, 17B, and 17C are various aberration graphs (a spherical aberration graph, an astigmatism graph, a distortion graph, a coma aberration graph, and a lateral chromatic aberration graph) of the zoom lens ZL7 according to Example 7 upon focusing on infinity with FIG. 17A corresponding to the wide angle end state, FIG. 17B corresponding to the intermediate focal length state, and FIG. 17C corresponding to the telephoto end state.

It can be seen in the aberration graphs in FIGS. 17A, 17B, and 17C that the zoom lens ZL7 according to Example 7 can achieve an excellent imaging performance with various aberrations successfully corrected from the wide angle end state to the telephoto end state.

### EXAMPLE 8

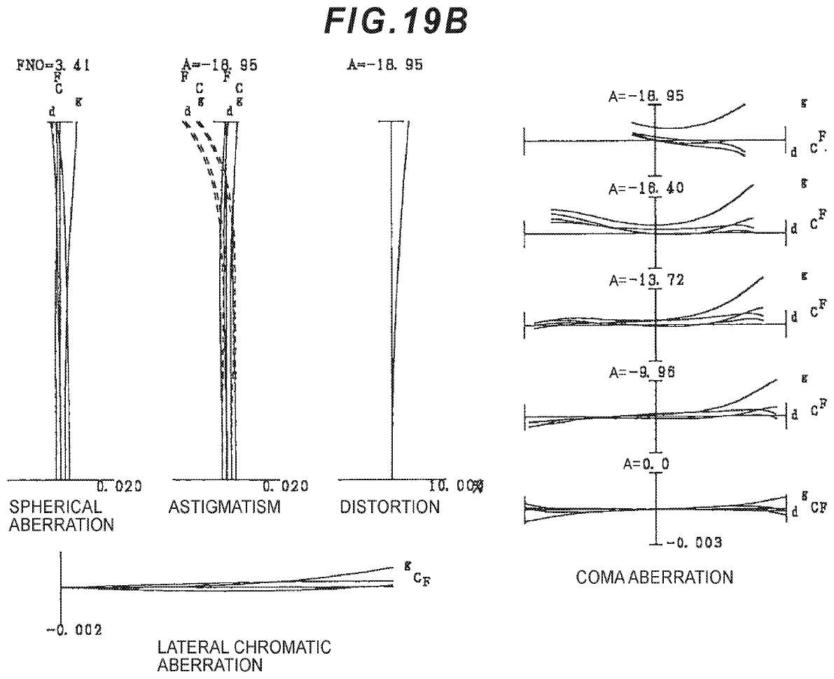

Example 8 is described with reference to FIG. 18, FIGS. 19A-19C, and Table 8. As illustrated in FIG. 18, a zoom lens ZL (ZL8) according to Example 8 includes: a first lens group G1 having positive refractive power; a second lens group G2 having negative refractive power; a third lens group G3 having positive refractive power; a fourth lens group G4 having negative refractive power; a fifth lens group G5 having positive refractive power; and a sixth lens group G6 having negative refractive power, which are disposed in order from an object.

The first lens group G1 includes: a cemented lens including a negative meniscus lens L11 having a concave surface facing the image side and a positive lens L12 having a biconvex shape; and a positive meniscus lens L13 having a convex surface facing the object side, which are disposed in order from the object.

The second lens group G2 includes: a negative lens L21 having a biconcave shape; a negative lens L22 having a biconcave shape; and a positive meniscus lens L23 having a convex surface facing the object side which are disposed in order from an object. The negative lens L21 having a biconcave shape has an aspherical surface on the image side.

The third lens group G3 includes: a positive lens L31 having a biconvex shape; a cemented lens including a positive lens L32 having a biconvex shape and a negative lens L33 having a biconcave shape; and a positive lens L34 having a biconvex shape, which are disposed in order from an object. The positive lens L31 having a biconvex shape has aspherical surfaces on both of the object side and the image side.

The fourth lens group G4 includes a negative meniscus lens L41 having a concave surface facing the image side. The negative meniscus lens L41 has an aspherical surface on the image side.

The fifth lens group G5 includes a positive lens L51 having a biconvex shape. The positive lens L51 having a biconvex shape has an aspherical surface on the object side.

The sixth lens group G6 includes a negative lens L61 having a biconcave shape.

An aperture stop S, for determining the brightness, is provided adjacent to and more on the object side than the third lens group G3.

A filter group FL is provided between the sixth lens group G6 and the image surface I. The filter group FL includes a glass block such as a lowpass filter and an infrared cut filter for cutting the spatial frequency overwhelming the resolution limit of a solid-state imaging device such as a CCD provided on the image surface I.

The zoom lens ZL8 according to the present example moves all the five lens groups G1 to G5 in such a manner that upon zooming from the wide angle end state to the telephoto end state, a distance between the first lens group G1 and the second lens group G2 increases, a distance between the second lens group G2 and the third lens group G3 decreases, a distance between the third lens group G3 and the fourth lens group G4 changes, a distance between the fourth lens group G4 and the fifth lens group G5 increases, and the distance between the fifth lens group G5 and the sixth lens group G6 changes, with the sixth lens group G6 fixed. Specifically, upon zooming, the first lens group G1 is moved toward the object side, the second lens group G2 is moved toward the image side, the third lens group G3 is moved toward the object side, the fourth lens group G4 is moved toward the image side and then is moved toward the object side, the fifth lens group G5 is moved toward the image side, and the sixth lens group G6 is fixed relative to the image surface I. The aperture stop S integrally moves with the third lens group G3 toward the object side upon zooming.

In Table 8 below, specification values in Example 8 are listed. Surface numbers 1 to 27 in Table 8 respectively correspond to the optical surfaces m1 to m27 in FIG. 18.

TABLE 8
[Lens specifications]

| Surface | | | | |
|---|---|---|---|---|
| number | R | D | nd | νd |
| Obj | ∞ | | | |
| surface | | | | |
| 1 | 8.89085 | 0.13208 | 1.795040 | 28.69 |
| 2 | 4.46088 | 0.43868 | 1.497000 | 81.73 |
| 3 | −31.62016 | 0.00943 | | |
| 4 | 3.84519 | 0.34906 | 1.603000 | 65.44 |
| 5 | 14.60955 | D5(Variable) | | |
| 6 | −15.52439 | 0.11321 | 1.772502 | 49.50 |
| *7 | 1.10451 | 0.41981 | | |
| 8 | −1.86882 | 0.09434 | 1.603000 | 65.44 |
| 9 | 9.45792 | 0.01887 | | |
| 10 | 2.97124 | 0.18396 | 1.945944 | 17.98 |
| 11 | 53.16567 | D11(Variable) | | |
| 12 | ∞ | 0.09434 | (Stop S) | |
| *13 | 1.38124 | 0.33019 | 1.693500 | 53.20 |
| *14 | −6.87672 | 0.07547 | | |
| 15 | 2.27290 | 0.25943 | 1.497000 | 81.73 |
| 16 | −10.35192 | 0.06604 | 1.728250 | 28.38 |
| 17 | 1.14816 | 0.09434 | | |
| 18 | 3.10652 | 0.25943 | 1.487490 | 70.32 |
| 19 | −2.26350 | D19(Variable) | | |
| 20 | 7.07547 | 0.09434 | 1.553319 | 71.68 |
| *21 | 2.12367 | D21(Variable) | | |
| *22 | 3.49230 | 0.34906 | 1.618806 | 63.85 |
| 23 | −3.13357 | D23(Variable) | | |
| 24 | −6.15520 | 0.08491 | 1.516800 | 63.88 |
| 25 | 94.33962 | 0.05660 | | |
| 26 | 0.00000 | 0.11038 | 1.516800 | 63.88 |
| 27 | 0.00000 | Bf | | |
| Img | ∞ | | | |
| surface | | | | |

[Aspherical surface data]
7th surface
K = 0.0000,A4 = −1.62825E−02,A6 = −9.14805E−03,A8 = 0.00000E+00,
A10 = 0.00000E+00
13th surface
K = 0.0000,A4 = −3.43965E−02,A6 = 0.00000E+00,A8 = 0.00000E+00,
A10 = 0.00000E+00
14th surface
K = 0.0000,A4 = 3.97330E−02,A6 = 0.00000E+00,A8 = 0.00000E+00,
A10 = 0.00000E+00
21th surface
K = 0.0000,A4 = 0.00000E+00,A6 = 4.43810E−02,A8 = −5.14186E−02,
A10 = 0.00000E+00
22th surface
K = 0.0000,A4 = −3.86599E−02,A6 = 1.45631E−02,A8 = 0.00000E+00,
A10 = 0.00000E+00
[Overall specifications]
Zooming rate 10.015094

| | Wide angle | | Telephoto |
|---|---|---|---|
| | end | Intermediate | end |
| f | 1.00000 | 2.17925 | 10.015094 |
| FNo | 2.78608 | 3.41054 | 3.83859 |
| ω | 37.99043 | 18.94664 | 4.14745 |
| TL | 8.44916 | 8.89612 | 11.03760 |
| Bf | 0.13481 | 0.13481 | 0.13458 |

[Zooming data]

| | Wide angle | | Telephoto |
|---|---|---|---|
| | end | Intermediate | end |
| D5 | 0.10879 | 1.28574 | 3.89850 |
| D11 | 2.54544 | 1.27004 | 0.22170 |
| D19 | 0.17547 | 1.16496 | 0.84167 |
| D21 | 1.31096 | 0.97360 | 2.20341 |
| D23 | 0.53972 | 0.43300 | 0.10377 |

[Zoom lens group data]

| Group | Group | Group | Lens |
|---|---|---|---|
| | starting | focal | configuration |
| number | surface | length | length |
| G1 | 1 | 6.48269 | 0.92925 |
| G2 | 6 | −1.18711 | 0.83019 |
| G3 | 13 | 1.80063 | 1.08491 |
| G4 | 20 | −5.52154 | 0.09434 |
| G5 | 22 | 2.72388 | 0.34906 |
| G6 | 24 | −11.17751 | 0.25189 |

[Conditional expression]
Conditional expression (12) f1/(fw × ft) ^{1/2} = 2.033
Conditional expression (13) f4/(fw × ft) ^{1/2} = 1.731
Conditional expression (14) Dm5/(fw × ft) ^{1/2} = 0.137
Conditional expression (15) −f2/ft = 0.117
Conditional expression (16) D5/ft = 0.0343
Conditional expression (17) Dm4/ft = 0.045
Conditional expression (18) ωt = 4.14745
Conditional expression (19) ωw = 37.99043

It can be seen in Table 8 that the zoom lens ZL8 according to Example 8 satisfies the conditional expressions (12) to (19).

FIGS. 19A, 19B, and 19C are various aberration graphs (a spherical aberration graph, an astigmatism graph, a distortion graph, a coma aberration graph, and a lateral chromatic aberration graph) of the zoom lens ZL8 according to Example 8 upon focusing on infinity with FIG. 19A corresponding to the wide angle end state, FIG. 19B corresponding to the intermediate focal length state, and FIG. 19C corresponding to the telephoto end state.

It can be seen in the aberration graphs in FIGS. 19A, 19B, and 19C that the zoom lens ZL8 according to Example 8 can achieve an excellent imaging performance with various aberrations successfully corrected from the wide angle end state to the telephoto end state.

With the examples described above, a zoom lens having a high zooming rate, and having high optical performance can be provided.

Elements of the 2nd embodiment are described above to facilitate the understanding of the present invention. It is a matter of course that the present invention is not limited to these. The following configurations can be appropriately employed without compromising the optical performance of the zoom lens ZL according to the present application

The numerical values of the configurations with the five and six groups are described as an example of values of the zoom lens ZL according to the 2nd embodiment. However, this should not be construed in a limiting sense, and the present invention can be applied to a configuration with other number of groups (for example, seven groups or the like). More specifically, a configuration further provided with a lens or a lens group closest to an object or further provided with a lens or a lens group closest to the image may be employed. The lens group is a portion including at least one lens separated from another lens with a distance varying upon zooming or focusing.

The zoom lens ZL according to the 2nd embodiment may have the following configuration. Specifically, upon focusing on a short-distant object from infinity, part of a lens group, one entire lens group, or a plurality of lens groups may be moved in the optical axis direction as the focusing lens group. The focusing lens group may be applied to auto focusing, and can be suitably driven by a motor (such as an ultrasonic motor for example) for auto focusing. At least a part of the fourth lens group G4 is especially preferably used as the focusing lens group.

In the zoom lens ZL according to the 2nd embodiment, any of the lens groups may be entirely or partially moved with a component in a direction orthogonal to the optical axis, or may be moved and rotated (swing) within an in-plane direction including the optical axis, to serve as the vibration-proof lens group for correcting image blur due to camera shake or the like. At least a part of the third lens group G3 is especially preferably used as the vibration-proof lens group.

In the zoom lens ZL according to the 2nd embodiment, the lens surface may be formed to have a spherical surface or a planer surface, or may be formed to have an aspherical shape. The lens surface having a spherical surface or a planer surface features easy lens processing and assembly adjustment, which leads to the processing and assembly adjustment less likely to involve an error compromising the optical performance, and thus is preferable. Furthermore, there is an advantage that a rendering performance is not largely compromised even when the image surface is displaced. The lens surface having an aspherical shape may be achieved with any one of an aspherical shape formed by grinding, a glass-molded aspherical shape obtained by molding a glass piece into an aspherical shape, and a composite type aspherical surface obtained by providing an aspherical shape resin piece on a glass surface. A lens surface may be a diffractive surface. The lens may be a gradient index lens (GRIN lens) or a plastic lens.

In the zoom lens ZL according to the 2nd embodiment, the aperture stop S is preferably disposed in the neighborhood of the third lens group G3. Alternatively, a lens frame may serve as the aperture stop so that the member serving as the aperture stop needs not to be provided.

In the zoom lens ZL according to the 2nd embodiment, the lens surfaces may be provided with an antireflection film featuring high transmittance over a wide range of wavelengths to achieve an excellent optical performance with reduced flare and ghosting and increased contrast.

The zoom lens ZL according to the 2nd embodiment has a zooming rate in a range of approximately 5 to 20.

### EXPLANATION OF NUMERALS AND CHARACTERS

| | |
|---|---|
| ZL | (ZL1 to ZL8) zoom lens |
| G1 | first lens group |
| G2 | second lens group |
| G3 | third lens group |
| G4 | fourth lens group |
| G5 | fifth lens group |
| G6 | sixth lens group |
| S | aperture stop |
| FL | filter |
| I | image surface |
| CAM | digital still camera (optical apparatus) |

1. A zoom lens comprising: a first lens group having positive refractive power; a second lens group having negative refractive power; a third lens group having positive refractive power; a fourth lens group having negative refractive power; and a fifth lens group having positive refractive power which are disposed in order from an object, wherein
upon zooming from a wide angle end state to a telephoto end state, the first lens group, the second lens group, the third lens group, the fourth lens group, and the fifth lens group are moved along an optical axis to change a distance between the first lens group and the second lens group, a distance between the second lens group and the third lens group, a distance between the third lens group and the fourth lens group, and a distance between the fourth lens group and the fifth lens group, and
wherein a following conditional expression is satisfied
2.30<f5/d4w<3.60
where,
f5 denotes a focal length of the fifth lens group, and
d4w denotes a distance between the fourth lens group and the fifth lens group in the wide angle end state.

2. The zoom lens according to claim 1, wherein a following conditional expression is satisfied
0.110<TLt×f3/(ft×ft)<0.134
where,
TLt denotes the total length of the whole zoom lens in the telephoto end state,
f3 denotes a focal length of the third lens group, and
ft denotes a focal length of the whole zoom lens in the telephoto end state.

3. The zoom lens according to claim 1, wherein upon focusing from infinity to a short-distant object, the fourth lens group is moved toward an image side as a focusing lens group.

4. The zoom lens according to claim 1, wherein a following conditional expression is satisfied
32.96<ft×ft/{(−f4)×d3t}<59.21
where,
ft denotes the focal length of the whole zoom lens in the telephoto end state,
f4 denotes a focal length of the fourth lens group,
d3t denotes a distance between the third lens group and the fourth lens group in the telephoto end state.

5. The zoom lens according to claim 1, wherein a following conditional expression is satisfied
1.00°<ωt<7.50°
where,
ωt denotes a half angle of view in the telephoto end state.

6. The zoom lens according to claim 1, wherein a following conditional expression is satisfied
32.00°<ωw<47.00°
where,
ωw denotes a half angle of view in the wide angle end state.

7. The zoom lens according to claim 1, wherein a following conditional expression is satisfied
1.70<f1/(fw×ft)^{1/2}<2.80
where,
f1 denotes a focal length of the first lens group,
fw denotes a focal length of the zoom lens in the wide angle end state, and
ft denotes a focal length of the zoom lens in the telephoto end state.

8. The zoom lens according to claim 1, wherein a following conditional expression is satisfied
0.67<f4/(fw×ft)^{1/2}<2.10
where,
f4 denotes a focal length of the fourth lens group,
fw denotes a focal length of the zoom lens in the wide angle end state, and
ft denotes a focal length of the zoom lens in the telephoto end state.

9. The zoom lens according to claim 1, wherein a following conditional expression is satisfied
0.100<Dm5/(fw×ft)^{1/2}<0.270
where,
Dm5 denotes a difference in a position of the fifth lens group on the optical axis between the wide angle end state and the telephoto end state (with a value increasing in accordance with displacement toward the image side).
fw denotes a focal length of the zoom lens in the wide angle end state, and
ft denotes a focal length of the zoom lens in the telephoto end state.

10. The zoom lens according to claim 1, wherein a following conditional expression is satisfied
0.052<(−f2)/ft<0.150
where,
f2 denotes a focal length of the second lens group, and ft denotes a focal length of the zoom lens in the telephoto end state.

11. The zoom lens according to claim 1, wherein a following conditional expression is satisfied
0.020<D5/ft<0.050
where,
D5 denotes a thickness of the fifth lens group on the optical axis, and
ft denotes a focal length of the zoom lens in the telephoto end state.

12. The zoom lens according to claim 1, wherein a following conditional expression is satisfied
0.005<(−Dm4)/ft<0.100
where,
Dm4 denotes a difference in a position of the fourth lens group on the optical axis between the wide angle end state and the telephoto end state (with a value increasing in accordance with displacement toward the image side), and
ft denotes a focal length of the zoom lens in the telephoto end state.

13. An optical apparatus comprising the zoom lens according to claim 1.

14-25. (canceled)

26. A method for manufacturing a zoom lens including: a first lens group having positive refractive power; a second lens group having negative refractive power;
a third lens group having positive refractive power; a fourth lens group having negative refractive power; and a fifth lens group having positive refractive power which are disposed in order from an object,
upon zooming from a wide angle end state to a telephoto end state, the first lens group, the second lens group, the third lens group, the fourth lens group, and the fifth lens group moving along an optical axis to change a distance between the first lens group and the second lens group, a distance between the second lens group and the third lens group, a distance between the third lens group and the fourth lens group, and a distance between the fourth lens group and the fifth lens group, the method comprising:
arranging
the lens groups in a lens barrel with a following conditional expression satisfied
2.30<f5/d4w<3.60
where,
f5 denotes a focal length of the fifth lens group, and
d4w denotes a distance between the fourth lens group and the fifth lens group in the wide angle end state.

27-30. (canceled)
